(19) United States
(12) Patent Application Publication
(10) Pub. No.: US 2026/0300870 A1
(43) Pub. Date: Oct. 1, 2026

(54) WORKFLOW ASSESSMENT AND RECOMMENDATION

(71) Applicant: Honeywell International, Inc., Charlotte, NC (US)

(72) Inventors: Ankit Singh, Apex, NC (US); Shaun Vallejo, Red Bank, NJ (US); Lakshminarayana Paila, Frisco, TX (US)

(21) Appl. No.: 19/090,398

(22) Filed: Mar. 26, 2025

(51) Int. Cl. G06Q 10/0633

(52) U.S. Cl. CPC G06Q 10/0633

(57) ABSTRACT

Techniques for assessment of a workflow and generation of recommendations are disclosed. A workflow record comprising operation specification for each of the interlinked operations is obtained. The operation specification is encoded into vector specifications, and a semantic conformity assessment is performed between the vector specifications and prescribed vector specifications derived from a reference workflow record. The reference workflow record includes prescribed operation specifications and linked data objects. Based on the assessment, a candidate set of prescribed operations semantically conforming with the operational workflow's operations is identified. A recommendation generation signal is then generated to cause rendering of the candidate set of prescribed operations and their linked data objects. The approach enables probable enhancement of the workflow by identifying and suggesting relevant operations and associated data from a reference workflow record.

### BACKGROUND

Organizations often employ a variety of predefined workflow models for different industrial purposes. These workflow models may include interconnected processes or operations that may be performed to serve an industrial objective. For instance, workflow models may include one or more steps or processes that may assist in determination of definitive decisions regarding a product. Further, various types of data and applications are used to implement the workflow models, or the operations linked therewith. For instance, the data may provide insights into different aspects of a product, while the applications may process the data to produce outcomes. However, there are multiple challenges that introduce inefficiencies in the implementation of the predefined workflow models.

### BRIEF DESCRIPTION OF DRAWINGS

The detailed description is described with reference to the accompanying figures. It should be noted that the description and figures are merely examples of the present subject matter and are not meant to represent the subject matter itself.

FIGS. 1A to 1C illustrate a block diagram of a computing environment, according to an example implementation of the present subject matter.

FIG. 2A illustrates a block diagram of a workflow record linked with an operational workflow, according to one example implementation of the present subject matter.

FIG. 2B illustrates a block diagram of the workflow record comprising an operation specification linked with each of the plurality of interlinked operations of the operational workflow, according to one example implementation of the present subject matter.

FIG. 3A illustrates a block diagram of a reference workflow record linked with a plurality of prescribed operations, according to one example implementation of the present subject matter.

FIG. 3B illustrates a block diagram of the reference workflow record comprising a prescribed operation specification linked with each of the plurality of prescribed operations, according to one example implementation of the present subject matter.

FIG. 4 illustrates a block diagram of a system, according to one example implementation of the present subject matter.

FIG. 5 illustrates a block diagram of a computing environment comprising the system, according to one example implementation of the present subject matter.

FIG. 6 illustrates a block diagram of the graphical user interface, according to one example implementation of the present subject matter.

FIG. 7 illustrates a block diagram of an updated graphical user interface, according to an example implementation of the present subject matter.

FIG. 8 illustrates an exemplary method for assessment of an operational workflow and generating recommendations based on the assessment, according to one example implementation of the present subject matter.

FIG. 9 illustrates a block diagram of a graphical user interface indicating operation-tool combinations, according to one example implementation of the present subject matter.

FIG. 10 illustrates a non-transitory computer-readable medium for assessing an operational workflow and generating a recommendation, according to one example implementation of the present subject matter.

Throughout the drawings, identical reference numbers designate similar, but not necessarily identical, elements. The figures are not necessarily scaled, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Typically, an industrial environment may encompass multiple industrial operations. The industrial operations may be, for instance, any activity or process carried out within the industrial environment. In one example, the industrial operations may be decision-making operations that may be implemented with an intent to conclusively determine a decision for products, services, platforms, or other offerings. The decision may be, in one example, for recalling or making modifications to an offering.

To assist such industrial operations, multiple solutions have been developed. For example, these operations often utilize predefined workflow models comprising interlinked steps, processes, and checks that may be implemented for concluding the industrial operations. For example, an organization may follow a predefined workflow model including multiple interlinked operations to be performed to conclude a decision regarding recalling a product. Such models may include operation specifications detailing the functional characteristics of each step, such as purpose, outcome, and required checks.

Further, organizations maintain data and records that provide insights into various aspects of their offerings. These are utilized during workflow implementation to derive outcomes. For example, the data may provide insights about the manufacturing of a product, the quality of the product, and the like. Such data may be utilized during implementation of the workflow model and to derive an outcome. In some examples, tools or applications may also utilized for processing the data at one or more interlinked stages or operations during implementation of the workflow model and derive an outcome based on the data.

However, multiple challenges exist with such workflow models. For example, the predefined workflow models are generally designed to meet bare minimum requirements, with generalized operation specifications for being applicable to a variety of products. Thus, such generalized models lack deeper details about necessary procedures. For instance, the operation specification, linked with the workflow model or each of the interlinked operations, may indicate generic or limited details, such as checks and validations to be performed. This limitation restricts the workflow models from incorporating additional beneficial operations or improving existing steps. That is, such operation specifications may restrict the workflow models from utilizing other possible procedures or operations, in addition to the already included procedures, that may help in precisely and confidently determining the decisive conclusion. Also, any drawbacks in the existing steps or processes in the workflow model, that can be improved, may remain unknown or unexplored due to its limited and fixed nature.

Further, the generalized nature of these models provides inadequate support for complex decision-making processes, particularly in scenarios requiring nuanced analysis or consideration of multiple variables. Furthermore, these workflow models often lack adaptive capabilities, making them less suitable for new or complex products that require more detailed or additional checks. The fixed nature of these models may not account for unique product characteristics and requirements, potentially overlooking critical factors or nuances. This inflexibility can be particularly problematic in industries with evolving regulatory requirements, where fixed models may struggle to adapt quickly to new compliance standards, potentially exposing organizations to regulatory risks.

Integration challenges also arise when attempting to incorporate these predefined workflow models with new technologies or systems. This can result in reduced interoperability and difficulties in leveraging advanced analytics or automation technologies to enhance industrial operations. Adapting existing workflow models for different technologies or products is often time-consuming and resource-intensive, making it an undesirable option for many organizations.

The rigid structure of these workflow models inhibits continuous improvement and optimization, potentially leading to persistent operational inefficiencies. Their limited scope can result in ineffective industrial operations, particularly in complex or rapidly evolving environments. As industries continue to advance and face new challenges, the limitations of these traditional workflow models become increasingly apparent, highlighting the need for more flexible and comprehensive solutions.

According to examples of the present subject matter, techniques for assessment of one or more operational workflows are described. In one example, the present subject matter also discloses rendering or generation of recommendations for the one or more operational workflows. In one example, the present subject matter addresses the limitations of the workflow models by assessing such workflow models and recommending improvements therefor.

In one example operation, a workflow record linked with an operational workflow may be obtained. The operational workflow, in one example, may be an existing workflow model that may assist, or be used for, any industrial operation. For example, the existing workflow model may be used for decision-making processes. The operational workflow may comprise a plurality of interlinked operations, where each operation may be associated with an operation specification that indicates generalized functional characteristics of that operation. For example, the operation specification may specify the purpose of the operation in the operational workflow.

The operation specification, linked with each of the interlinked operations, may then be encoded into a vector specification. That is, the operation specification linked with each of the plurality of interlinked operations may be transformed into a corresponding vector specification. Thus, each of the plurality of interlinked operations may have a vector specification linked therewith. Further, a semantic conformity assessment may be performed between the encoded vector specifications and prescribed vector specifications derived for a plurality of prescribed operations identified in a reference workflow record. For example, the semantic conformity assessment may be performed between each encoded vector specification, linked with a corresponding operation from amongst the plurality of interlinked operations, and each prescribed vector specification, linked with a corresponding prescribed operation from amongst the plurality of prescribed operations. In one example, the prescribed vector specification may be derived based on a prescribed operation specification linked with each of the plurality of prescribed operations and indicated in the reference workflow record. In one example, the prescribed operation specification may indicate a functional attribute of the corresponding prescribed operation. The reference workflow record may also indicate, in one example, a plurality of prescribed data objects, where one or more of the plurality of prescribed data objects may be linked with at least one prescribed operation from amongst the plurality of prescribed operations.

In one example, the reference workflow record may be a repository of prescribed operations, their specifications, and associated data objects. These prescribed operations may represent, for example, a vast set of potential workflow steps or operations derived from extensive data of workflow models, client interactions, best practices across industries, and the like. Thus, the reference workflow record may indicate the prescribed operations and the prescribed specification, linked therewith, indicating their functional attributes. The functional attributes may be, for example, any parameter, detailed process or action, expected outcome, investigation or check, and the like described and recommended for that prescribed operation. Further, the prescribed data objects may indicate, in one example, at least one of data prescribed for utilization for prescribed operation or a characteristic of the data prescribed for utilization for the prescribed operations.

Further, the semantic conformity assessment may involve, in one example, computing similarity scores between the vector specifications and the prescribed vector specifications. The scores may then be compared against a threshold similarity score to identify vector specifications that may be semantically conforming with prescribed vector specifications, that are further linked with corresponding prescribed operations. Thus, based on the semantic assessment, a candidate set of prescribed operations that semantically conforms with one or more of the interlinked operations in the operational workflow may be identified. A recommendation generation signal may then be generated to cause rendering of the candidate set of prescribed operations and their associated prescribed specifications and data objects. In one example, a graphical user interface may be rendered to indicate these recommendations.

Further, in one example, the graphical user interface may also include one or more actionable components for each prescribed operation in the candidate set of prescribed operations. The one or more actionable components may include, in one example, a first actionable component, a second actionable component, and a third actionable component. In one example, the first actionable component may be capable of receiving positive feedback for the prescribed operation, the positive feedback indicating acceptance of the prescribed operation for the operational workflow. Whereas, the second actionable component may be capable of receiving a negative feedback for the prescribed operation, the negative feedback indicating rejection of the prescribed operation for the operational workflow. Further, the third actionable component may be capable of receiving a modification feedback, the modification feedback indicating a request for modifying at least one of the prescribed operation specification and the prescribed data object linked with the prescribed operation. in one example, the feedback may be received from a user.

For the accepted operations, in one example, a tool recommendation signal may be generated to suggest operation assistive tools prescribed for performing each prescribed operation in the candidate set of prescribed operations. In one example, the operation assistive tool may be any software, an application, or a platform recommended for each prescribed operation in the candidate set of prescribed operations. In one example, the operation assistive tool may be capable of performing the prescribed operations in the candidate set of prescribed operations. For example, the operation assistive tool may be related to data extraction, transformation, and loading operations.

In one example, it may also be determined whether the functional characteristics of the existing interlinked operations of the operational workflow conform with the functional attributes of the recommended operations. Based on the determination, a variation indication signal may be generated to indicate probable differences between the existing and recommended specifications associated with the operations.

The present subject matter may address the problems associated with conventional workflow models and provide several significant technical advantages. For example, the ability to transform qualitative information into a quantifiable or vector format and perform semantic conformity assessments allows for a more nuanced and accurate evaluation of existing workflow models. Vector representations may facilitate precise similarity measurements and detection of subtle differences. Thus, the vector-based approach allows for a more sophisticated, scalable, and context-aware analysis of workflow models, leading to more accurate identification of improvement areas and relevant enhancement suggestions.

Further, by leveraging a reference workflow record, the techniques disclosed by the present subject matter may suggest improvements over existing operational workflows that may be non-obvious or may not be immediately apparent, potentially uncovering more efficient or effective ways of performing operations or reaching a decisive conclusion. The comprehensive workflow record derived from, for example, diverse industry practices, enables nuanced comparisons through semantic conformity assessments. Thus, the techniques may assist in identifying more efficient operations, uncovering cross-industry applicable practices, revealing opportunities for better data utilization, and highlighting overlooked steps. Such a data-driven approach allows for the discovery of enhancements that may not be apparent through traditional analysis, leading to more efficient operations and effective decision-making processes. Thus, unlike generic workflow models, the disclosed techniques may provide additional details, addressing the limitation of overly generalized workflow models.

The disclosed techniques also enhance adaptability of existing workflow models to new products, services, and regulatory requirements by recommending relevant prescribed operations from the comprehensive reference workflow record. Such a capability facilitates organizations in complying with evolving regulations and product-specific requirements. Also, by incorporating prescribed data objects linked to recommended operations, data-driven workflow improvements may be ensured. Furthermore, the identification and recommendation of appropriate operations and tools may enable optimization of workflow models, or at least their implementation, potentially reducing inefficiencies and improving overall operational effectiveness. Such an adaptive approach may allow for continuous refinement of workflows in response to changing business needs and regulatory landscapes.

Therefore, the present subject matter offers advantages in workflow assessment and generating data-driven recommendations for workflow improvement. By providing enhanced evaluation techniques and intelligent suggestions, the present subject matter enables organizations to continuously refine their operational processes. The also approach facilitates better alignment with evolving industry standards and regulatory requirements, while uncovering opportunities for increased efficiency and effectiveness. Further, the ability to adapt to new challenges and incorporate best practices from diverse sources ensures that workflow models remain optimized and compliant in dynamic business environments.

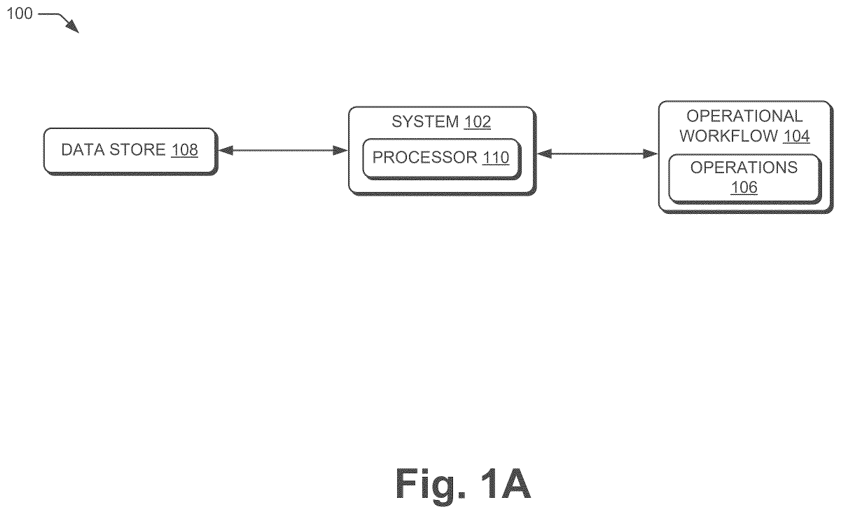

The above techniques are further described with reference to FIGS. 1A to 8. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A to 1C illustrate a block diagram of a computing environment 100, according to an example implementation of the present subject matter. FIGS. 1A to 1C may be discussed in conjunction with each other.

The computing environment 100 may be any computing environment comprising the system 102. In one example, the computing environment 100 may be an industrial process environment. The industrial process environment may be an industrial setting where industrial processes or workflows are carried out, for instance, in one or more processing facilities. Examples of the processing facilities may include, but are not limited to, manufacturing units, assembling units, testing units, and material processing units or plants. The processing facilities could also be units related to other different sectors. For example, the processing facilities may be related to oil and gas, petrochemicals, pharmaceuticals, food and beverage, chemical processing, metallurgical engineering, content delivery network, data management, data processing, software development and/or management, and automobile sector. Other examples of the processing facilities may also be possible.

In one example, the computing environment 100 may have an operational workflow 104 linked therewith. The operational workflow 104 may be, in one example, a set of interrelated operations 106 that may be performed to achieve a specific objective in, or with respect to, the computing environment 100. In one example, the operational workflow 104 may be an existing workflow followed in the computing environment 100. The operational workflow 104 may serve as an existing schema for implementing operations or tasks in a desired manner. The operational workflow 104 may have been designed to handle input (for example, data, materials, or actions), process it through predefined interlinked operations, and produce output (for example, products, decisions, or insights). The operational workflow 104 can include sequential operations 106 where one operation depends on the completion of another, parallel operations 106 that occur simultaneously, or conditional operations 106 that follow specific rules or decision points.

In one example, the computing environment 100 may be the industrial process environment, where the operational workflow 104 may exist and comprise the interlinked operations 106 related to an industrial process. For instance, the interlinked operations 106 may be related to the production of a product. In such a case, the interlinked operations 106 may be, for example, procuring raw materials, followed by transporting them to an assembly line. The assembly line performs tasks or operations such as assembling components, applying finishes, and conducting quality checks. The final steps may include packaging the finished product and shipping it to customers. Thus, the operational workflow related to the production of the product may include a plurality of interlinked operations 106.

In another example, the operational workflow 104 may be related to recall decision-making and may comprise the plurality of interlinked operations 106 involved in making recall decisions for a product. The plurality of operations 106 may be, for instance, identification of an issue and assessing the impact, followed by procuring manufacturing data, product complaints, and other product-related data. One or more of the operations 106 may also include conducting tests for the product and obtaining test results. Based on the data, further operations may be performed to determine whether to recall the product, and accordingly, the recall may be planned, and corrective measures may be decided. Such steps or operations 106 may be a part of, or may collectively be referred to as, the operational workflow 104. Similarly, in an industrial setting or environment, there may exist multiple operational workflows having a plurality of interlinked operations, where the workflow and operations may be related to some industrial process or to achieve a specific task or objective.

In yet another example, the computing environment 100 may be a data processing environment, where the operational workflow 104 may comprise the interlinked operations 106 related to data management and processing. For example, the data processing environment may refer to the infrastructure and conditions under which data may be collected, processed, stored, and analyzed. In such an environment, the operational workflow 104 may comprise the interlinked operations 106 related to, for example, transforming raw data into actionable insights. For instance, the operational workflow 104 may be a business intelligence workflow that begins with extracting/obtaining data from multiple sources, such as databases, followed by cleaning and organizing the data. The data may then be loaded into a data warehouse where it may be analyzed using specialized tools or software. The final operation may involve creating dashboards or reports that visualize key insights, enabling stakeholders to make informed decisions. Similarly, in a data processing environment, there may exist multiple operational workflows having a plurality of interlinked operations.

The above-discussed examples of the computing environment 100, the operational workflow 104, and the plurality of operations 106 are for illustration purposes. The computing environment 100 can be any environment where the operational workflow 104 may exist and comprise the plurality of operations 106 structured in a logical manner. The operational workflow 104 may map the interlinked operations 106. Further,

Further, in one example, a plurality of such operational workflows can also exist in the computing environment 100, where each of the plurality of operational workflows may have its corresponding set of operations. For example, as illustrated in FIG. 1B, the computing environment 100 may include a plurality of operational workflows 104-1 to 104-N, where N is a natural number, and each of the plurality of operational workflows may have its corresponding set of operations. For instance, the operational workflow 104-1 may comprise interlinked operations 106-1 and 106-2, and the operational workflow 104-N may comprise interlinked operations 106-3 to 106-M, where M is a natural number. The plurality of operational workflows may hereinafter collectively be referred to as the plurality of operational workflows 104 and individually be referred to as the operational workflow 104, and the plurality of interlinked operations may hereinafter collectively be referred to as the plurality of interlinked operations 106 and individually be referred to as an operation 106. It may also be possible, in one example, that the operational workflow 104 may comprise a single operation, though not illustrated.

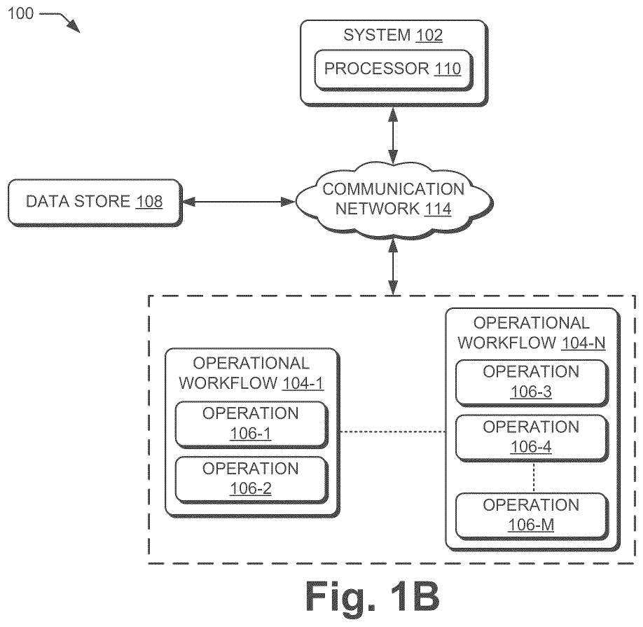

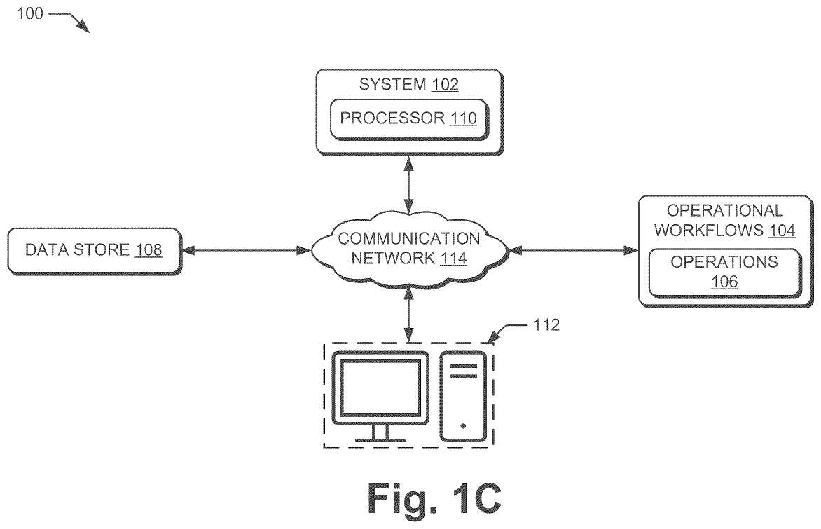

Further, in one example, the operational workflow 104 may have a workflow record linked therewith. FIG. 2A illustrates a block diagram of a workflow record 202 linked with the operational workflow 104, according to one example implementation of the present subject matter. Similarly, in case of multiple operational workflows 104, each operational workflow 104 of the computing environment 100 may have a workflow record linked therewith. In another example, a single workflow record, such as the workflow record 202, can also contain workflow records of each of the operational workflows 104.

In one example, the workflow record 202 may comprise an operation specification linked with each of the plurality of interlinked operations 106 of the operational workflow 104. FIG. 2B illustrates a block diagram of the workflow record 202 comprising an operation specification linked with each of the plurality of interlinked operations 106 of the operational workflow 104, according to one example implementation of the present subject matter. For example, as illustrated, the workflow record 202 may be linked with the operational workflow 104-N and include an operation specification 204-3 linked with the operation 106-3; and another operation specification 204-M linked with the operation 106-M of the operational workflow 104-N. Thus, each operation 106 of the operational workflow 104 may have a corresponding operation specification, hereinafter commonly referred to as the operation specification 204.

The operation specification 204 may indicate, in one example, a functional characteristic of each of the plurality of interlinked operations 106 of the operational workflow 104. For example, the operation specification 204-3 may indicate a functional characteristic of the operation 106-3, whereas the operation specification 204-M may indicate a functional characteristic of the operation 106-M of the operational workflow 104. The functional characteristic, in one example, may be descriptive information about the operation. For example, the functional characteristics may indicate the operation's purpose, detailing what it aims to achieve within the operational workflow 104. In another example, the functional characteristics may indicate the execution method, providing instructions or algorithms for performing the operation. The functional characteristics may also detail dependencies on other operations and time constraints for execution. Similarly, there may be other examples of information that may be indicated by the operation specification. However, such information may be limited or generic in nature for being suitable for a wide range of scenarios or products. Further, the functional characteristics may be indicated in a machine-readable format. For example, the functional characteristics may be indicated in the operation specification in at least one of textual and non-textual format.

Further, in one example, the computing environment 100 may comprise a data store 108. The data store 108 may be capable of storing the workflow record 202 linked with each of the operational workflows 104. The data store 108 may include, for example, a set of storage devices capable of storing data and information, for instance, the workflow records The set of storage devices may be virtual storage devices, physical storage devices, a cloud-based storage service, or a combination thereof. For example, the data store 108 may be any repository or storage unit implemented by physical, logical, and/or virtual storage devices. In one example, the data store 108 may include a set of physical storage devices. In another example, the data store 108 may include virtual storage devices being implemented on physical storage devices. In another example, the data store 108 may include one or more physical or logical storage units that may either be located at the same location or distributed geographically. In another example, the data store 108 may be implemented over a cloud-based storage service. Further, the data store 108 may be a single data store or a combination of two or more data stores.

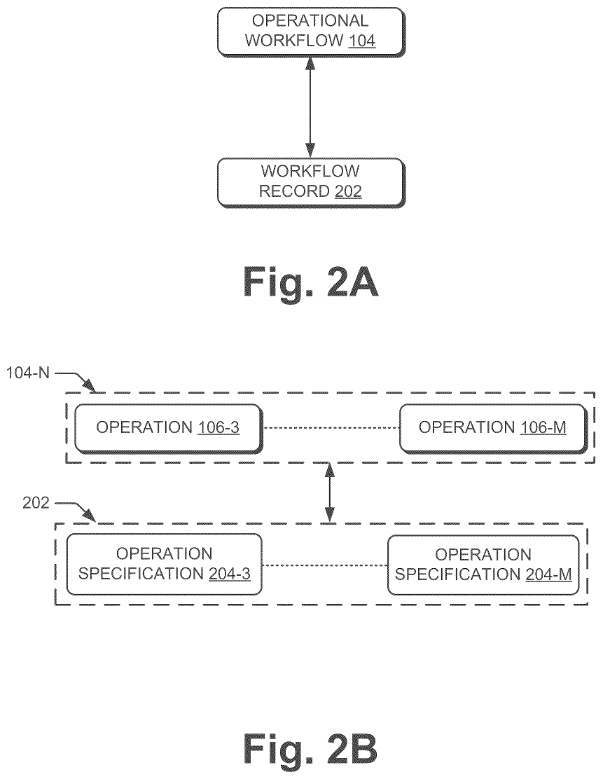

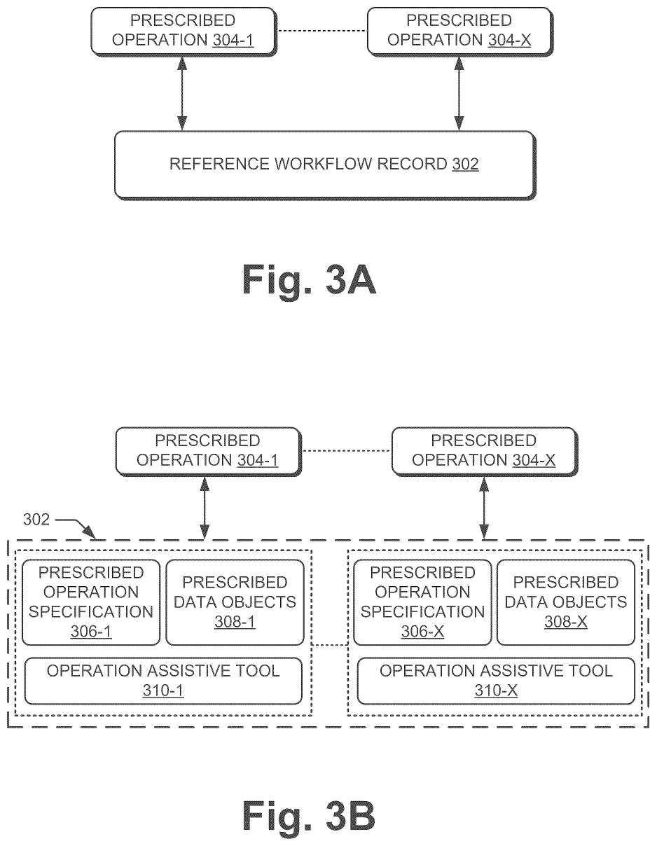

Further, in one example, the data store 108 may also store a reference workflow record 302 (illustrated in FIG. 3A). In one example, the reference workflow record 302 and the workflow record 202 may be stored in the same data store 108, or in secure and distinct virtual containers in the data store 108. In another example, if the data store 108 may comprise multiple data stores, the reference workflow record 302 and the workflow record 202 may be stored in different data stores.

In one example, the reference workflow record 302 may identify a plurality of prescribed operations, as illustrated in FIG. 3A. FIG. 3A illustrates a block diagram of the reference workflow record 302 linked with a plurality of prescribed operations 304-1 to 304-X (where X is a natural number), according to one example implementation of the present subject matter. The plurality of prescribed operations may hereinafter collectively be referred to as prescribed operations 304 and individually be referred to as prescribed operation 304.

The reference workflow record 302 may identify the plurality of prescribed operations 304 for the computing environment 100. For example, the reference workflow record 302 may define or indicate operations that may be prescribed or suggested for enhanced functioning of the computing environment 100. That is, the reference workflow record 302 may define or illustrate a wide range of tasks, processes, or procedures that are recommended or required and may probably optimize functioning of the computing environment 100. In some cases, the prescribed operations 304 may be tailored to the specific configuration, hardware components, or software applications present in the computing environment 100. This comprehensive identification of prescribed operations 304 in the reference workflow record 302 may serve as a reference guide or guiding framework to ensure that the computing environment 100 is maintained and operated according to desired or optimal industrial practices and policies. These prescribed operations 304 may represent, for example, a vast set of potential workflow steps or operations identified based on interaction with clients (such as organizations), best practices across industries, and the like.

Further, the reference workflow record 302 may indicate various details about each prescribed operation 304. In one example, the reference workflow record 302 may indicate a plurality of prescribed operation specifications, where each prescribed operation may have a prescribed operation specification linked therewith, as illustrated in FIG. 3B. FIG. 3B illustrates a block diagram of the reference workflow record 302 comprising a prescribed operation specification linked with each of the plurality of prescribed operations 304, according to one example implementation of the present subject matter. For example, as illustrated, the reference workflow record 302 may indicate, or include, a prescribed operation specification 306-1 linked with the prescribed operation 304-1; and another operation specification 306-X linked with the prescribed operation 304-X. Thus, each prescribed operation 304 may have a corresponding prescribed operation specification linked therewith, and hereinafter commonly referred to as the prescribed operation specification 306.

The prescribed operation specification 306 may indicate, in one example, a functional attribute of each of the plurality of prescribed operations 304. For example, the prescribed operation specification 306-1 may indicate a functional attribute of the prescribed operation 304-1, whereas the prescribed operation specification 3064-M may indicate a functional characteristic of the prescribed operation 304-X. The functional attribute, in one example, may be detailed or comprehensive descriptive information about the prescribed operation. For example, the functional attribute may indicate the prescribed operation's purpose, detailing what it aims to achieve. In another example, the functional attribute may indicate detailed instructions or algorithms for performing the prescribed operation. The functional attribute may also clearly define input requirements and output expectations for the prescribed operation 304. In one example, the functional attribute may also indicate performance metrics and error handling procedures. The functional attribute may also detail dependencies on other operations, time constraints for execution, and resource allocation requirements for the operation. In one example, security considerations and compliance requirements may also be specified by the functional attribute to ensure adherence to regulatory standards and protection of sensitive information. The functional attribute may also indicate data flow descriptions illustrating prescribed information and how that information may move through the prescribed operation. In one example, the functional attribute may indicate monitoring parameters for tracking execution of the prescribed operation, and rollback procedures in case of failures. The functional attribute may be any of the above information or a combination thereof. Similarly, there may be other examples of comprehensive information that may be indicated by the prescribed operation specification. Thus, the functional attributes may define comprehensive information about the prescribed operations 304 that may indicate, but not limited to, the operation's purpose, how the operation may be performed, input requirements, expected outcomes, compliance requirements, performance metrics, error handling procedures, time constraints for execution, and/or resource allocation requirements. Further, the functional attributes may be indicated in a machine-readable format. For example, the functional attributes may be indicated in the prescribed operation specification 306 in at least one of textual and non-textual format. Thus, each prescribed operation 304 may have a corresponding prescribed operation specification 306 linked to it, a functional attribute of that prescribed operation, which may be comprehensive descriptive information.

In one example, the reference workflow record 302 may also indicate a plurality of prescribed data objects 308, as illustrated in FIG. 3B. In one example, each of the plurality of prescribed operations 304 may have one or more prescribed data objects 308 associated therewith. For example, the prescribed operation 304-1 may have prescribed data objects 308-1 associated therewith and the prescribed operation 304-X may have prescribed data objects 308-X associated therewith. Similarly, each of the plurality of prescribed operations 304 may have one or more prescribed data objects associated therewith. The plurality of prescribed data objects 308 may hereinafter collectively be referred to as prescribed data objects 308 and individually be referred to as prescribed data object 308.

Each of the prescribed data objects 308 may indicate at least one of data linked with its corresponding prescribed operation 304 and a characteristic of data linked with its corresponding prescribed operation 304. For example, the prescribed data objects 308-3 may indicate samples of data linked with the prescribed operation 304-1. In one example, the data samples may indicate the data recommended to be utilized for performing the prescribed operation 304-1. Examples of such recommended data may include, but are not limited to, manufacturing-related information about a wide range of products and/or services, complaints and feedback typically received about such products and/or services, compliance requirements, checks and procedures to be performed for the wide range of products and/or services, resource requirements for performing that prescribed operation 304, and other information or updates for a wide range of products and/or services. In one example, the data may be embedded in machine-readable documents, files, or reports. Examples of such reports or documents may include, but are not limited to, analytical reports, review reports, operational performance reports, quality reports, maintenance logs, datasheets, manuals, project reports, catalogues, and the like. Thus, the data may be any information capable of providing insights about different aspects related to a wide range of products, services, platforms, or other offerings.

In another example, the data indicated by the prescribed data objects 308 may include computer programs, data associated with one or more web pages, user or customer-related data, and research-related data. Similarly, other examples of the data indicated by each of the plurality of prescribed data objects 308 may also be possible. In another example, each of the plurality of prescribed data objects 308 may indicate a characteristic of the data linked with its corresponding prescribed operation 304. Examples of such characteristics may include, but are not limited to, data types, data format, data quality, and data source. Further, though it has been illustrated that a plurality of data objects 308 may be linked with a prescribed operation, it may also be possible, in another example, that one or more of the plurality of prescribed data objects 308 may be linked with at least one of the plurality of prescribed operations. it may also be possible that a prescribed operation may have one or more common or same data objects from amongst the plurality of data objects.

Further, in one example, the reference workflow record 302 may also indicate a plurality of prescribed operation assistive tools, as illustrated in FIG. 3B, for each of the plurality of prescribed operations 304. For example, a prescribed operation assistive tool 310-1 may be linked with the prescribed operation 304-1 and another prescribed operation assistive tool 310-X may be linked with the prescribed operation 304-X. In one example, a mapping of multiple such tools with a prescribed operation may also be possible, though not illustrated. The plurality of prescribed operation assistive tools may interchangeably and collectively be referred to as operation assistive tools 310 and individually be referred to as operation assistive tool 310.

In one example, the prescribed operation assistive tools 310 may be prescribed or recommended means that may be used for performing an operation. In one example, the prescribed operation assistive tools 310 may be machinery, equipments, or mechanical tools usable in industrial environments. Examples of such prescribed operation assistive tools 310 may include, but are not limited to, lathes, construction presses, printers, cutting tools, hammers, drills, grinders, furnaces, clamps, pneumatic tools, hydraulic tools, and measuring tools. In another example, the prescribed operation assistive tools 310 may be earth movers or construction vehicles. In yet another example, the prescribed operation assistive tools 310 may be software applications or platforms. Such prescribed operation assistive tools 310 may be capable of data extraction, data analytics, data transformation, data loading, data visualization or presentation, deriving intelligence from data, and the like. Examples of such prescribed operation assistive tools 310 may include, but are not limited to, Amazon QuickSight®, Informatica®, Amazon Athena®, Power BI®, and Tableau®. Other examples of the prescribed assistive operation tools 310 may include, but are not limited to, word processors, spreadsheets, presentation software, database management software, web browsers, email clients, graphic design software, project management tools, finance-related applications, social media applications or platforms, content delivery application or platform.

The reference workflow record 302 thus represents a vast and comprehensive set of data encompassing prescribed operation specifications, prescribed data objects 308, and prescribed operation assistive tools 310. This extensive collection of information may be suitable for diverse types of operations and across various domains. The breadth and depth of this reference record may allow it to serve as a versatile resource, potentially applicable to a wide range of scenarios, operations, and use cases within different industrial environments. By providing detailed specifications, relevant data objects, and recommended tools for each prescribed operation, the reference workflow record 302 may significantly assist in the efficient and effective performance of diverse operations, potentially enhancing productivity and ensuring adherence to best practices across multiple operational contexts.

Such a comprehensive reference workflow record 302 may be prepared based on interaction with clients (such as organizations), best practices across industries, and the like. The creation of a comprehensive reference workflow record 302 may involve several stages and inputs from various sources. Initially, detailed information about specific operational requirements, operations, and best practices may be collected from various sources. For example, such inputs may be gathered through extensive interviews of experts, surveys, or direct observation of workflows in action, and data available on internet and other data sources or databases. Further, information about industry standards, regulatory requirements, best practices, common patterns, essential steps, and critical data points that should be considered for performing operations in an industrial process environment, may also be collected. For example, in a manufacturing context, experts or extensive data may pinpoint key quality control checkpoints, optimal equipment settings, and required safety protocols that should be universally applied.

To illustrate, consider a reference workflow record 302 for a pharmaceutical manufacturing process. The high-level operation or process might be “Drug Production,” which could be broken down into sub-processes like “Raw Material Sourcing,” “Chemical Synthesis,” “Quality Control,” and “Packaging.” For the “Chemical Synthesis” sub-process, the record might specify prescribed operations such as “Reagent Mixing,” “Reaction Monitoring,” and “Product Isolation.” Each of these operations would have associated data objects (e.g., chemical formulas, reaction parameters, yield data) and assistive tools (e.g., automated mixing equipment, spectroscopic analyzers, filtration systems). The development of the reference workflow record 302 may also involve iterative refinement and validation. As draft versions of the record are created, they could be tested in real-world scenarios or simulations to ensure their effectiveness and comprehensiveness. Feedback from these tests would then be incorporated to improve the record 302 further.

Additionally, the creation process might leverage advanced technologies such as artificial intelligence (AI) and machine learning (ML). These tools could be used to analyze vast amounts of historical operational data, identifying patterns and insights that humans might miss. For instance, AI might discover subtle correlations between certain process parameters and product quality, leading to the inclusion of new prescribed operations or data objects in the reference workflow record. Further, the creation of such a record, in one example, may be a continuous process rather than a one-time event. As industries evolve, new technologies emerge, regulatory requirements change, and the like, the reference workflow record 302 may be regularly updated to remain relevant and effective. This could involve monitoring industry trends, technological advancements, and regulatory changes, and incorporating these updates into the record.

Thus, the creation of a comprehensive reference workflow record 302 may be a multifaceted process that combines inputs or data from domain experts, data analysis, technological tools, real-world validation, and other possible sources. The result is a document (reference workflow record 302) that serves as a valuable resource for guiding diverse operations across various domains, potentially enhancing efficiency, consistency, and best practice adherence in numerous operational contexts. In one example, the reference workflow record 302 may be stored in the data store 108.

Further, the computing environment 100 may include the system 102. In one example, the system 102 may be capable of assessing one or more operational workflows. In one example, the assessment may be based on the workflow record 202 and the reference workflow record 302. In one example, the system 102 may be capable of rendering or generation of recommendations for the one or more operational workflows.

In one example, the system 102 may be implemented in the computing environment 100 as a set of one or more hardware devices or modules. For example, the system 102 may be implemented as a set of one or more hardware devices, comprising at least a processor 110. The processor 110 may be implemented as a dedicated processor, a shared processor, or a plurality of individual processors, some of which may be shared. Examples of the processor 110 may include, but are not limited to, microprocessors, microcomputers, microcontrollers, digital signal processors, central processing units, state machines, Artificial Intelligence (AI) based processors, machine learning-based processors, deep learning-based processors, system-on-chip (SOC), processing circuitries including one or more modules or engines, and/or any other devices that manipulate signals and data based on computer-readable instructions.

In another example, the system 102 may be implemented as a set of computer-executable instructions. In this example, the processor 110 may be an engine capable of executing the set of computer-executable instructions that may process the operations data for data reconciliation and recommend a range of values for the parameters. Examples of the system 102, according to this example, may include, but are not limited to, software applications, cloud-based platforms, and Software as a Service (SaaS). In yet another example, the system 102 may be implemented as a combination of the one or more hardware devices and the set of computer-executable instructions. In this example, the set of computer-executable instructions may be executed by the processor 110 to process the operations data for data reconciliation and recommend a range of values for the parameters.

Further, in one example, the computing environment 100 may also include a workstation 112, as illustrated in FIG. 1C. In some examples, the workstation 112 may be a software-based application or tool. Examples of such tools and software may include, but are not limited to, data analysis tools, business software, websites or webpages, cloud-hosted platforms, analytical tools, and statistical tools. In some instances, the workstation 112 may be a hardware-based device. Examples of such workstation 112 may include, but are not limited to, a computing system or a desktop, a mobile, a laptop, Supervisory Control and Data Acquisition (SCADA) system. Such a workstation 112, in one example, may execute software-based applications or tools that may be accessed by a user. A user may be, for example, an engineer, operator, worker, or any other industrial expert associated with the industrial process environment. Further, in one example, the workstation 112 may comprise a display device and an input mechanism. The input mechanism may be, for example, a keyboard, mouse, or even a touch input received on the display device of the workstation 112. In one example, the display device may be capable of rendering graphical user interface(s). The workstation 112 may render one or more graphical user interfaces that may indicate different information about the industrial process environment. The graphical user interface may be, for example, an interactive interface with which the user may be able to interact and view different information related to the industrial process environment and/or the components therein. For example, the user may be able to submit queries and view, interact, modify, and customize the information being rendered via the display device and the input mechanism associated with the workstation 112. In one example, the graphical user interface may be a dashboard that may be rendered on the display device.

Further, the system 102, the operational workflow 104 (optional), the data store 108, and the workstation 112 (optional) may be communicably coupled with each other to exchange data and/or signals. In one example, the coupling may be direct, either wirelessly or through one or more wires. In another example, the system 102, the operational workflow 104 (optional), the data store 108, and the workstation 112 (optional) may be communicably coupled via a communication network 114, as illustrated in FIGS. 1B and 1C, to exchange data and/or signals. The computing environment 100 may thus be a network of such entities that may be communicably coupled with each other, for example, over the communication network 114 to exchange data and/or signals. Examples of the communication network 114 may include, but are not limited to LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 114 may include various network entities, such as transceivers, gateways, and routers. In an example, the communication network 114 may include any communication network that uses any of the commonly used protocols, for example, Hypertext Transfer Protocol (HTTP), and Transmission Control Protocol/Internet Protocol (TCP/IP).

Thus, the computing environment 100 illustrates an example of an industrial process environment having different entities or components, and different combinations thereof, that may be communicably coupled with each other. Further, FIGS. 1A and 1C illustrate that the system 102 may be communicably coupled with the operational workflow 104 (optional), the data store 108, and the workstation 112 (optional). However, other implementations may also be possible. For example, the system 102 may only be communicably coupled with the data store 108 to access the workflow record 202 and the reference workflow record 302 stored therein. In another example, the system 102 may comprise the processor 110 and the data store 108 (having the reference workflow record 302), and such system 102 may be communicably coupled with the operational workflow 104 to obtain the workflow record 202 linked with the operational workflow 104. Similarly, different architectures may also be possible, though not illustrated.

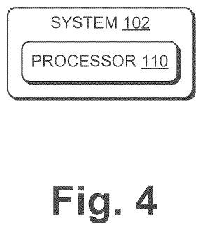

FIG. 4 illustrates a block diagram of the system 102, according to one example implementation of the present subject matter. FIG. 4 may be discussed in conjunction with FIGS. 1A to 3B for the sake of brevity and the description of FIGS. 1A to 3B shall be incorporated herein for reference. In one example, the system 102 may be capable of assessing the operational workflow 104 and rendering recommendations for the operational workflow 104.

In one example, the system 102 may comprise the processor 110. In one example operation, the processor 110 may obtain the workflow record 202 linked with the operational workflow 104. In one example, the processor 110 may obtain the workflow record 202 in response to receiving a workflow assessment signal for evaluating the operational workflow 104 comprising the plurality of interlinked operations 106. The workflow record 202 may comprise, in one example, the operation specification 204 linked with each of the plurality of interlinked operations 106. The operation specification 204 may indicate a functional characteristic of each of the plurality of interlinked operations 106.

Further, the processor 110 may encode the operation specification 204 linked with each of the plurality of interlinked operations 106 into a vector specification. The processor 110 may then perform a semantic conformity assessment between the vector specification and a prescribed vector specification derived for each of the plurality of prescribed operations 304 identified in the reference workflow record 302. The reference workflow record 302 may indicate, in one example, the prescribed operation specification 306 linked with each of the plurality of prescribed operations 304. The prescribed operation specification 306 may indicate a functional attribute of each of the plurality of prescribed operations 304. The prescribed vector specification may be derived, for each of the plurality of prescribed operations 304, based on the prescribed operation specification 306 linked with each of the plurality of prescribed operations 304. The reference workflow record 302 may also indicate the plurality of prescribed data objects 308, where one or more of the plurality of prescribed data objects 308 may be linked with at least one prescribed operation from amongst the plurality of prescribed operations 304.

Based on the semantic conformity assessment, the processor 110 may identify a candidate set of prescribed operations. The candidate set of prescribed operations comprises one or more of the plurality of prescribed operations 304 semantically conforming with one or more of the plurality of interlinked operations 106 of the operational workflow 104. The processor 110 may then generate a recommendation generation signal to cause rendering of the candidate set of prescribed operations and one or more prescribed data objects linked with each of the one or more prescribed operations in the candidate set of prescribed operations.

Thus, by leveraging a comprehensive reference workflow record 302, the system 102 may be capable of suggesting non-obvious improvements to existing operational workflow 104, potentially uncovering more efficient ways of performing operations. The system 102 may also be capable of enhancing adaptability to new products, services, and regulatory requirements by recommending relevant prescribed operations, and assisting in complying with evolving regulations. Further, incorporating prescribed data objects 308 linked to recommended operations 304 may ensure data-driven improvements, while the identification and recommendation of appropriate operations 304 may enable optimization and enhancement of existing workflow 104. Thus, the system 102 may offer advantages in workflow assessment and improvement, and in enabling continuous refinement of operational processes in response to changing business needs and regulatory landscapes. The system 102 may also facilitate alignment with industry standards, uncover opportunities for increased efficiency, and ensure that workflow 104 may remain optimized and compliant in dynamic business environments by incorporating information about different practices from diverse sources.

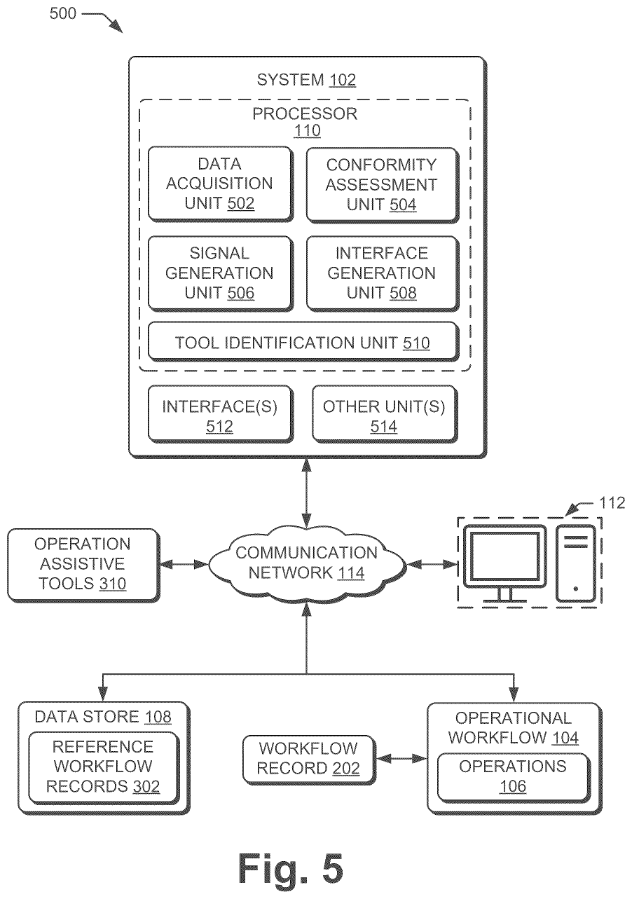

FIG. 5 illustrates a block diagram of a computing environment 500 comprising the system 102, according to one example implementation of the present subject matter. FIG. 5 will be discussed in conjunction with FIGS. 1A to 3B for the sake of brevity and the description of FIGS. 1A to 3B shall be incorporated herein for reference.

In one example, the computing environment 500 may be similar to the computing environment 100, as discussed in reference to FIGS. 1A to 1C. The computing environment 500 may comprise the system 102 communicably coupled with the data store 108, and at least one of the operation assistive tools 310, the workstation 112, the operational workflow 104, and the workflow record 202 of the operational workflow 104.

In one example, the system 102 may be capable of assessing the operational workflow 104, or the workflow record 202 linked with the operational workflow 104, and rendering recommendations for the operational workflow 104. The assessment may involve, in one example, assessment of the workflow record 202 linked with the operational workflow 104 based on the reference workflow record 302. Based on this comprehensive assessment, the system 102 may identify areas for improvement within the operational workflow 104. These areas may include operation performance bottlenecks, inefficient implementations, or underutilized resources in the existing operational workflow 104. Based on the potential areas for enhancement, the system 102 may generate a set of recommendations tailored to optimize the operational workflow 104. For instance, if the system 102 identifies inefficiencies, in the existing operational workflow 104 based on the workflow record 202, that could be addressed by implementing specific tools or alternative methodologies or tasks, the system 102 may suggest these through the recommendations.

The system 102 may present these recommendations in a user-friendly format, for example, through visualizations, simulations, or comparative analyses between the workflow record 202 and the reference specification 302 to illustrate the potential benefits of implementing the suggested changes. Furthermore, the system 102 may be capable of continuous monitoring and adaptation. As changes are implemented in the operational workflow 104, the system 102 may track their effectiveness and provide ongoing feedback, in view of the reference workflow record 302. This iterative process may allow for continuous refinement and optimization of the operational workflow 104 over time, ensuring that it remains efficient and effective even with changing requirements or external factors of the operational workflow 104, or the operations 106 linked therewith.

In one example, the system 102 comprises the processor 110. The processor 110 may be implemented as a dedicated processor, a shared processor, or a plurality of individual processors, some of which may be shared. Examples of the processor 110 may include, but are not limited to, microprocessors, microcomputers, microcontrollers, digital signal processors, central processing units, state machines, Artificial Intelligence (AI) based processors, machine learning-based processors, deep learning-based processors, system on chip (SOC), processing circuitries including one or more modules or engines, and/or any other devices that manipulate signals and data based on computer-readable instructions, and/or any other devices.

In one example, the processor 110 may include one or more sub-processing units or engines. For example, the processor 110 may comprise a data acquisition unit 502, a conformity assessment unit 504, a signal generation unit 506, an interface generation unit 508, and a tool identification unit 510. The units may be implemented as a combination of hardware and programming, for example, programmable instructions to implement a variety of functionalities of the units. In examples described herein, such combinations of hardware and programming may be implemented in several different ways. For example, the programming for the units or engines may be executable instructions. Such instructions in turn may be stored on a non-transitory machine-readable storage medium which may be coupled with the system 102 either directly or indirectly (for example, through networked means). In an example, it may also be possible that each of the units or engines includes a processing resource, for example, a single processor or a combination of multiple processors, to execute such instructions. In one example, such instructions may be stored in a memory of other unit(s) 514 of the system 102. In other examples, the units or engines may be implemented as electronic circuitry.

The system 102 may further comprise, in one example, interface(s) 512. The interface(s) 512 may include a variety of software and hardware interfaces that allow interaction of the system 102 with other communication and computing devices, such as network entities, web servers, external repositories, and peripheral devices, such as input/output (I/O) devices. For example, the interface(s) 512 may communicably couple the system 102 with at least one of the data store 108, the operation assistive tools 310, the workstation 112, and the operational workflow 104 or the workflow record 202 of the operational workflow 104. The interface(s) 512 may also enable the coupling of internal components of the system 102 with each other.

The system 102 may further comprise, in one example, the other unit(s) 514. The other unit(s) 514 may include, in one example, a power supply unit, a communication unit, and the memory. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with at least one of the data store 108, the operation assistive tools 310, the workstation 112, and the operational workflow 104 or the workflow record 202 of the operational workflow 104. Also, the communication unit may allow the system 102 to transmit and receive data, files, and/or signals.

Further, the memory may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes. In one example, the memory may store the data received, processed, or generated by the system 102 and/or the processor 110.

In one example operation, the processor 110, or the data acquisition unit 502, may obtain the workflow record 202 linked with the operational workflow 104. The processor 110 may obtain the workflow record 202, in one example, from a user. Examples, of the user may include, but are not limited to, engineer, operator, worker, or any other industrial expert. The workflow record 202 may be in the form of a machine-readable file, record, document, or text. In one example, the user may be enabled to submit the workflow record 202 through the workstation 112 which may then be obtained by the processor 110. For example, the workstation 112 may be a graphical user interface, or a computing device rendering such an interface, allowing the user to submit the workflow record 202.

In another example, the processor 110 may obtain the workflow record 202 in response to receiving a workflow assessment signal for evaluating the operational workflow 104 comprising the plurality of interlinked operations 106. In one example, the user may submit a request or query, through the workstation 112, to assess the operational workflow 104. The workflow assessment signal may be, for example, the query or the request, or any signal being generated upon submission of such query or request. Such a workflow assessment signal may be communicated to the processor 110. In response to receiving the workflow assessment signal, the processor 110 may obtain the workflow record 202 linked with the operational workflow 104, which is to be assessed. In one example, the workflow assessment signal may comprise the workflow record 202, and the processor 110 may obtain the workflow record 202 from the signal. In another example, the workflow record 202 linked with the operational workflow 104 may be stored in the data store 108, and the processor 110 may obtain the workflow record from the data store 108 in response to receiving the workflow assessment signal.

Further, the workflow record 202 may comprise the operation specification 204 linked with each of the plurality of interlinked operations 106, as indicated in FIG. 2B and discussed above. The operation specification 204 may indicate the functional characteristic of each of the plurality of interlinked operations 106, as discussed above. For example, the operation specification 204 may provide details about each operation within the operational workflow 104. These details, referred to as functional characteristics, may offer an understanding of the operation's role and execution. Functional characteristics may encompass various aspects that define the existing operation's purpose and implementation. For instance, the functional characteristics may outlines the objective and impact of the operation, say operation 106-3. This information may indicate why the operation is necessary and what it contributes to the operational workflow 104. Additionally, the execution method may be specified, providing instructions or algorithms for carrying out that operation.

While the operation specification aims to be detailed, it may generally be designed with flexibility in mind. The information provided is typically limited in nature or generic enough to accommodate a wide range of scenarios or products. For instance, the workflow record 202 associated with the operational workflow 104 of an organization might be restricted to information known by the organization or its experts. This record may not have been updated over time, potentially leading to outdated information. Additionally, it may contain only fundamental details, designed to be broad enough to fit various operations or workflows within the organization. The limitations of the workflow record 202 can significantly impact overall workflow efficiency. If the record hasn't been updated over time, it may contain outdated information, leading to decisions based on inaccurate data. This can potentially slow down processes and result in errors. Additionally, fundamental details that are too broad may not provide the key or additional specifics for certain operations that may be beneficial for the operation or the workflow. Without detailed and current information, the workflow may struggle to adapt to new challenges or integrate with advanced systems, reducing flexibility and responsiveness. Broad and fundamental details might not align well with more specialized or advanced workflows, causing integration issues and inefficiencies. Furthermore, if the record doesn't reflect changes in industry standards or regulatory requirements, it may lead to non-compliance issues, which can be costly and time-consuming to rectify. Overall, these factors can potentially lead to decreased productivity, increased operational costs, and a higher likelihood of errors and compliance issues.

Further, in response to obtaining the workflow record 202, the processor 110 or the conformity assessment unit 504, may encode the operation specification 204 linked with each of the plurality of interlinked operations 106 into a vector specification. That is, operation specification, of each operation, may be encoded or transformed into a corresponding vector specification. In one example, the processor 110 may utilize any technique to convert the information embedded in the operation specification 204 into vector specification. For example, the processor 110 may transform words, phrases, or entire operation specification 204 into numerical representation. One approach may be to use frequency-based representations, where text is encoded based on how often words or tokens appear. Each word may be assigned a value reflecting its occurrence within a document or across multiple documents, creating a straightforward representation of text. Another method may focus on capturing the context in which words appear. Contextual representations encode the meaning of a word by analyzing its surrounding words in the operation specification 204. This approach may ensure that words with similar meanings or usage patterns are represented by similar vectors, enhancing the understanding of semantic relationships. In yet another example, statistical relationships between words, such as their co-occurrence patterns, can also be used to generate vectors. Words frequently appearing together or in similar contexts are positioned closer to each other in the vector space.

In yet another example, predefined embeddings, developed using large datasets, provide another approach. These embeddings may assign pre-trained vectors to words, capturing nuanced semantic and syntactic details without the need for extensive training on specific tasks. Sequential and hierarchical encodings, on the other hand, transform text sequences or structures like sentences and paragraphs into vectors that capture dependencies and relationships within the text. In yet another example, one or more deep learning models may be used for encoding the operation specification 204 into vectors, referred to as vector specification. The vectors may be, for example, numerical vectors derived based on the textual description, or functional characteristics, indicated by the operation specification 204 linked with each of the plurality of interlinked operations 106.

The processor 110, or the conformity assessment unit 504, may then perform a semantic conformity assessment between the vector specification and a prescribed vector specification derived for each of a plurality of prescribed operations 304 identified in the reference workflow record 302. As discussed above and illustrated in FIG. 3B, the reference workflow record 302 may identify or indicate the plurality of operations 304 prescribed for the computing environment 500. That is, the reference workflow record 302 may define or illustrate a wide range of tasks, processes, or procedures that are recommended or required and may probably optimise the functioning of the computing environment 500, or the operational workflow 104. The comprehensive identification of prescribed operations 304 in the reference workflow record 302 may serve as a reference guide or guiding framework to ensure that the computing environment 500, or the operational workflow 104, is maintained and operated according to desired or optimal industrial practices and policies.

Further, as discussed above, the reference workflow record 302 may indicate various details about each prescribed operation 304. In one example, the reference workflow record 302 may indicate the plurality of prescribed operation specifications 306, where each prescribed operation 304 may have a prescribed operation specification 306 linked therewith, as illustrated in FIG. 3B. For example, as illustrated, the reference workflow record 302 may indicate, or include, a prescribed operation specification 306-1 linked with the prescribed operation 304-1; and another operation specification 306-X linked with the prescribed operation 304-X. Thus, each prescribed operation 304 may have a corresponding prescribed operation specification 306 linked therewith.

The prescribed operation specification 306 may indicate, in one example, a functional attribute of each of the plurality of prescribed operations 304. The functional attribute may be detailed or comprehensive descriptive information about the prescribed operation 304. For example, the functional attributes may define comprehensive information about the prescribed operations 304 that may indicate, but not limited to, the operation's purpose, how the operation may be performed, input requirements, expected outcomes, compliance requirements, performance metrics, error handling procedures, time constraints for execution, and/or resource allocation requirements, as discussed above. Further, the functional attributes may be indicated in a machine-readable format. For example, the functional attributes may be indicated in the prescribed operation specification 306 in at least one of textual and non-textual format.

In one example, the reference workflow record 302 may also indicate the plurality of prescribed data objects 308, as illustrated in FIG. 3B. Each of the plurality of prescribed operations 304 may have one or more prescribed data objects 308 associated therewith, as discussed above and illustrated in FIG. 3B. The plurality of prescribed data objects 308 may hereinafter collectively be referred to as prescribed data objects 308 and individually be referred to as prescribed data object 308. Each of the prescribed data objects 308 may indicate at least one of data linked with its corresponding prescribed operation 304 and a characteristic of data linked with its corresponding prescribed operation 304, as discussed above.

Further, in one example, the reference workflow record 302 may also indicate a plurality of prescribed operation assistive tools, as illustrated in FIG. 3B, for each of the plurality of prescribed operations 304. In one example, the prescribed operation assistive tools 310 may be prescribed or recommended means that may be used for performing an operation, as discussed above. In one example, the prescribed operation assistive tools 310 may be machinery, equipment, or mechanical tools usable in industrial environments. In another example, the prescribed operation assistive tools 310 may be software applications or platforms, as discussed above.

The reference workflow record 302 thus represents a vast and comprehensive set of data encompassing prescribed operation specifications, prescribed data objects 308, and prescribed operation assistive tools 310. This extensive collection of information may be suitable for diverse types of operations and across various domains. The breadth and depth of this reference record may allow it to serve as a versatile resource, potentially applicable to a wide range of scenarios, operations, and use cases within different industrial environments, as also discussed above. Such a comprehensive reference workflow record 302 may be prepared based on interaction with clients (such as organizations), best practices across industries, and the like. Detailed information about specific operational requirements, operations, and best practices may be collected from various sources, for example, through extensive interviews of experts, surveys, or direct observation of workflows in action, and data available on internet and other data sources or databases. Further, information about industry standards, regulatory requirements, best practices, common patterns, essential steps, and critical data points that should be considered for performing operations in an industrial process environment, may also be collected.

Additionally, vast amounts of historical operational data, identifying patterns and insights that humans might miss, may also be utilized for the preparation of the reference workflow record 302. For instance, AI might discover subtle correlations between certain process parameters and product quality, leading to the inclusion of new prescribed operations or data objects in the reference workflow record. Further, as industries evolve, new technologies emerge, regulatory requirements change, and the like, the reference workflow record 302 may be regularly updated to remain relevant and effective for wide range of workflows and/or operations. This could involve monitoring industry trends, technological advancements, and regulatory changes, and incorporating these updates into the record. Thus, the creation of a comprehensive reference workflow record 302 may be a multifaceted process that combines inputs or data from domain experts, data analysis, technological tools, real-world validation, and other possible sources. The result is a comprehensive or detailed reference workflow record 302 that serves as a valuable resource for guiding diverse operations across various domains, potentially enhancing efficiency, consistency, and best practice adherence in numerous operational contexts.

Further, the processor 110 or the conformity assessment unit 504 may derive a prescribed vector specification for each of the plurality of prescribed operations 304 identified in the reference workflow record 302. In one example, the prescribed vector specification may be vector representation, referred to as the prescribed vector specification, of the prescribed operation specification 306 linked with each of the plurality of prescribed operations 304. The processor 110 may encode the prescribed operation specification 306, linked with each of the plurality of prescribed operations 304, into vector representation using any of the techniques discussed above with reference to the encoding of the operation specification 204.

Further, in one example, derivation of the prescribed vector specification may be a one-time task. That is, the prescribed operation specifications 306 may be pre-encoded into vector representations and may be stored in the data store 108. The processor 110 may access the data store 108 to access such prescribed vector specifications, that correspond to the prescribed operations specifications 306. Further, in case of updates or modifications of the prescribed operation specification 306, the prescribed vector specification may be updated accordingly.

The processor 110, or the conformity assessment unit 504, may then perform the semantic conformity assessment between the vector specification, of the operation specification 204 linked with each of the plurality of interlinked operations 106, and the prescribed vector specification of the prescribed operation specification 306 linked with each of the plurality of prescribed operations 304. In one example, to perform the semantic conformity assessment, the processor 110 or the conformity assessment unit 504 may compute a similarity score for quantifying a semantic conformity or similarity between the vector specification, encoded based on the operation specification 204 linked with each of the plurality of interlinked operations 106, and the prescribed vector specification derived for each of the plurality of prescribed operations 304. For example, the processor 110 may compare each vector specification with each prescribed vector specification.

Based on the comparison of the vector specifications, the processor 110 may compute the similarity score for each such comparison. The similarity score may be computed using any known method. For example, the similarity score may be based on the distance between two vectors. A smaller distance may imply greater semantic similarity. In another example, similarity score may be computed based on measures of cosine of the angle between two vectors. The closer the cosine value is to 1, the more similar the vectors are. Similarly, different techniques may be used to compute the similarity score between two vectors. Thus, for each possible combination of a vector specification with a prescribed vector specification, a similarity score may be determined.

The processor 110 may then compare the similarity score with a threshold similarity score to identify one or more prescribed vector specifications, from amongst the prescribed vector specification derived for each of the plurality of prescribed operations 304, semantically conforming with one or more vector specifications from amongst the vector specification encoded for each of the plurality of interlinked operations 106. In one example, the threshold similarity score may be pre-defined by the user through the workstation 112, or any platform or software accessible to the user. If the processor 110 determines that the similarity score, determined for each combination of a vector specification with a prescribed vector specification, is equal to or greater than the threshold similarity score, the processor 110 may identify such combination of vector specification and prescribed vector specification to be semantically conforming or similar. The prescribed operations 304, linked with such semantically conforming prescribed vector specification, may be identified by the processor 110. One or more of such prescribed operations may collectively be referred to as a candidate set of prescribed operations. That is, the candidate set of prescribed operations may comprise one or more of the plurality of prescribed operations 304 that semantically conform, based on the prescribed vector specification, with one or more of the plurality of interlinked operations 106 of the operational workflow 104. Thus, the processor 110, based on the comparison, may identify the candidate set of prescribed operations comprising one or more of the plurality of prescribed operations 304, where the one or more of the plurality of prescribed operations semantically conform with one or more of the plurality of interlinked operations 106 of the operational workflow 104. For instance, based on semantically conforming vector specification and the prescribed vector specification, the processor 110 may identify the operation 106-3 to be conforming with the prescribed operation 304-1 and the operation 106-M to be conforming with the prescribed operation 304-3. The prescribed operations 304-1 and 304-3 may form the candidate set of prescribed operations.

However, if the processor 110 determines that the similarity score, determined for each combination of a vector specification with a prescribed vector specification, is less than the threshold similarity score, the processor 110 may identify such combination of vector specification and prescribed vector specification to be semantically non-conforming.

The processor 110, or the signal generation unit 506, may then generate a recommendation generation signal to cause rendering of the candidate set of prescribed operations and one or more prescribed data objects 308 linked with each of the one or more prescribed operations 304 in the candidate set of prescribed operations. In one example, the recommendation generation signal may be a signal or instruction that may cause rendering of the candidate set of prescribed operations and one or more prescribed data objects 308 linked with each of the one or more prescribed operations 304 in the candidate set of prescribed operations. In one example, such a signal may be communicated to the workstation 112 accessible to the user. The signal may cause the workstation 112 to render a graphical user interface, such as a dashboard, that may indicate the candidate set of prescribed operations and one or more prescribed data objects 308 linked with each of the one or more prescribed operations 304 in the candidate set of prescribed operations. In one example, rendering of the candidate set of prescribed operations may cause rendering of the prescribed operation specification, linked with each of the one or more prescribed operations 304 in the candidate set of prescribed operations.

As discussed above, the prescribed operation specification comprises vast and comprehensive information. Thus, the rendering may recommend comprehensive or additional operation specifications relevant to the existing operations 106 of the workflow 104. For example, the recommendation may indicate additional or alternative methodologies and checks that may be performed for the semantically conforming operation 106-3 for enhanced execution of that operation 106-3. The recommendation may also indicate appropriate resource allocation or requirements for the operation 106-3. Similarly, different valuable and additional information may be rendered for the interlinked operations 106 that semantically conform with the prescribed operations 304.

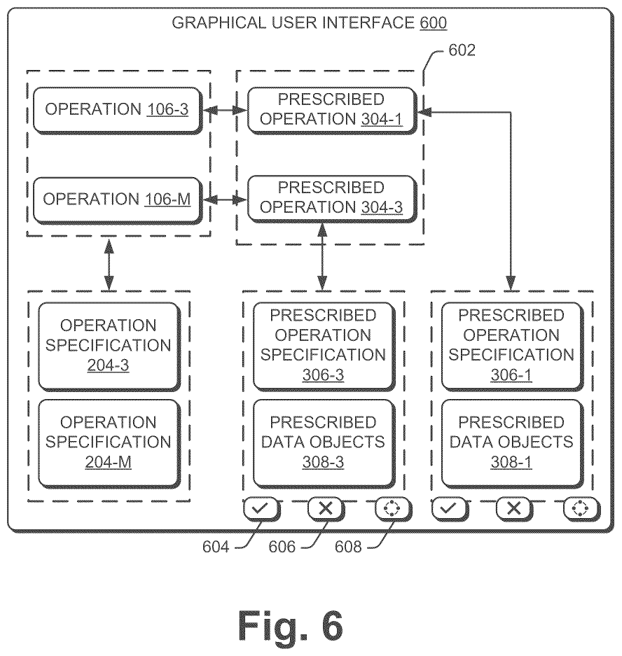

Further, in one example, the processor 110 or the interface generation unit 508 may cause rendering of a graphical user interface 600, in response to generation of the recommendation generation signal. FIG. 6 illustrates a block diagram of the graphical user interface 600, according to one example implementation of the present subject matter. In one example, the graphical user interface 600 may be rendered on the workstation 112.

The graphical user interface 600 may indicate one or more of the plurality of interlinked operations 106 semantically conforming with the candidate set of prescribed operations 602. For example, the graphical user interface 600 may indicate the operations 106-1 and/or 106-M, as illustrated. In one example, the operation specifications linked with such operations may also be rendered. For example, the operations specification 204-3, linked with the operation 106-3, and the operation specification 204-M, linked with the operation 106-M, may also be rendered. Further, the candidate set of operations 602 may also be rendered. Along with the candidate set of prescribed operations, the prescribed operation specification linked with each prescribed operation in the candidate set of prescribed operations may also be rendered. For example, the prescribed operation specification 306-1, linked with the prescribed operation 304-1, and the prescribed operation specification 306-3, linked with the prescribed operation 304-3, may also be rendered, as illustrated. Further, one or more prescribed data objects linked with each of the one or more prescribed operations in the candidate set of prescribed operations may also be rendered. In one example, all the above-discussed information may be rendered by the graphical user interface 600, as illustrated in FIG. 6. In another example, at least one of the above-discussed information can also be rendered by the graphical user interface 600.

Further, by rendering the operation specification along with the prescribed operation specification, the graphical user interface 600 may provide a comparison between the operation specification 204 of the existing operations 106 and the comprehensive and prescribed operation specification 306, thereby indicating additional information in comparison to the existing operation specification 204. For example, if the operation specification 204-3 indicates methodologies to perform the operation 106-3, the prescribed operation specification 306-1 may indicate additional or alternative methodologies to perform the prescribed operation 304-1 (semantically conforming with the operation 106-3). Similarly, other addition information may also be indicated by the prescribed operation specification 306. Similarly, the prescribed data objects 308 may indicate the data or characteristics of data prescribed for performing the interlinked operations 106.

Further, the processor 110 may cause rendering of one or more actionable components on the graphical user interface 600 for each prescribed operation in the candidate set of prescribed operations 602. The one or more actionable components may comprise a first actionable component 604, a second actionable component 606, and a third actionable component 608. In one example, such actionable components may be rendered for the prescribed operation specification and prescribed data object linked with each prescribed operation in the candidate set of prescribed operations 602, as illustrated. For example, the actionable components 604, 606, and 608 may be rendered for the prescribed operation specification 306-3 and the prescribed data object 308-3 linked with the prescribed operation 304-3. Similarly, for the prescribed operation 304-1 of the candidate set, the separate actionable components may be rendered with the prescribed operation specification 306-1 and the prescribed data object 308-1, as indicated.

In one example, each actionable component may be an interactable graphical component, such as a clickable button. The user may be able to interact with the actionable components, for instance, through the workstation 112. In one example, the first component 604 may be rendered to receive a positive feedback for the prescribed operation. The positive feedback may indicate acceptance of the prescribed operation for the operational workflow 104. Whereas, the second component 606 may be rendered to receive a negative feedback for the prescribed operation. The negative feedback may indicate rejection of the prescribed operation for the operational workflow 104. Further, the third component 608 may be rendered to receive a modification feedback. The modification feedback may indicate, in one example, a request for modifying at least one of the prescribed operation specification and the prescribed data object linked with the prescribed operation of the candidate set of prescribed operations 602. In one example, a window may be rendered on the graphical user interface 600 that may represent contents of the prescribed operation specification, say 306-1, and the prescribed data objects, say 308-1 in an editable format. The user may be able to interact with the content through the workstation 112 to modify the content. Thus, the graphical user interface 600 may not only allow acceptance or rejection of the prescribed operations (and thereby the prescribed specification and data objects linked therewith) being recommended, but may also allow modification of at least one of the prescribed operation specification and the prescribed data object linked with the prescribed operations of the candidate set of prescribed operations 602.

Further, as discussed above, the reference workflow record 302 may indicate at least one operation assistive tool 310 prescribed for performing each of the plurality of prescribed operations 304. In one example, in response to receiving the positive feedback for a prescribed operation from amongst the candidate set of prescribed operations 602, the processor 110 may generate a tool recommendation signal or instruction to cause rendering of a recommendation indicating the at least one operation assistive tool 310 prescribed for performing the prescribed operation of the candidate set of prescribed operations 602. For example, in response to receiving a positive feedback for the prescribed operation specification 306-1 and prescribed data objects 308-1, the processor 110 may ascertain that the recommendation is suitable for the interlinked operation 106-1. In response to receiving the positive feedback, the processor 110 (or the tool identification unit 510), may generate the tool recommendation signal or instruction to cause rendering of a recommendation indicating the operation assistive tool 310-1 prescribed for performing the prescribed operation 304-1 of the candidate set of prescribed operations 602. Such a recommendation may be indicative that the operation assistive tool 310-1 may also be suitable for performing the corresponding operation 106-1.

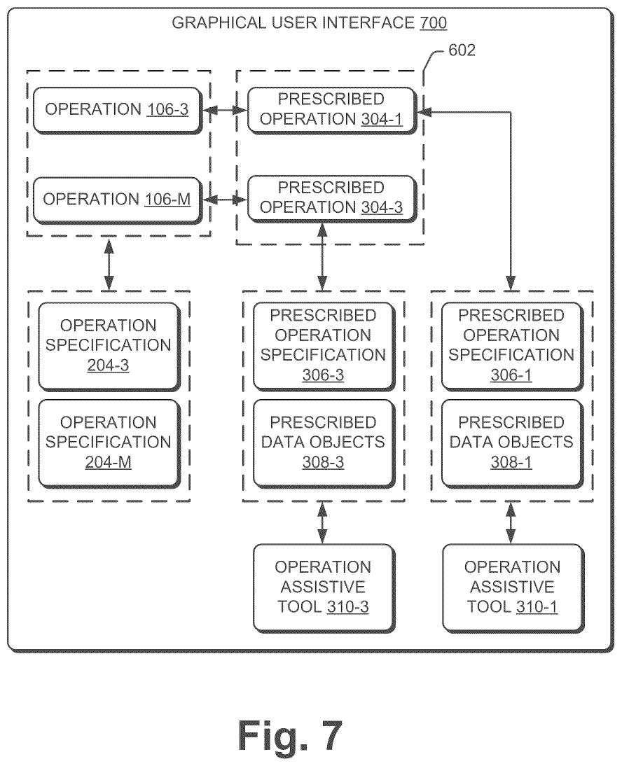

In one example, the graphical user interface 600 may be updated to render indications of the operation assistive tools being recommended for the prescribed operations 304, as illustrated in FIG. 7. FIG. 7 illustrates a block diagram of an updated graphical user interface 700, according to an example implementation of the present subject matter. For instance, if the positive feedback was received for the prescribed operations 304-1 and 304-3, the operations assistive tools 310-1 and 310-3 may be indicated on the graphical user interface 600, as illustrated. As the prescribed operations 304-1 and 304-3 correspond, semantically, to the interlinked operations 106-1 and 106-M, the recommended operations assistive tools may also be suitable and usable with the interlinked operations 106-1 and 106-M of the operational workflow 104. Thus, the graphical user interface 600 may recommend one or more operation assistive tools 310 that may be used for one or more of the interlinked operations 106.

Further, in one example, for the one or more of the plurality of prescribed operations 304 semantically conforming with one or more of the plurality of interlinked operations 106, the processor 110 may determine whether the functional characteristics indicated by the operation specification 204 linked with the one or more of the plurality of interlinked operations 106 conforms with the functional attribute prescribed for the one or more of the plurality of prescribed operations 304. For example, the processor 110 may compare the functional characteristics indicated by the operation specification 204-3 with the functional attribute indicated by the prescribed operation specification 306-1. Similarly, the functional characteristics of the interlinked operations 106, semantically conforming with one or more of the plurality of prescribed operations 304, may be compared with the functional attributes linked with those one or more of the plurality of prescribed operations 304. Based on the comparison, the processor 110 may determine whether there is any difference between the functional characteristics and the functional attributes being compared. In case there is no difference, the processor 110 may ascertain that the functional characteristics are already comprehensive and updated and comply with the functional attributes. However, if the processor 110 determines that there exist differences between the functional characteristics and the functional attributes being compared, the processor 110 may determine that the functional characteristics may not be comprehensive and/or updated and there exist additional features in the functional attributes.

Based on the determination, the processor 110 or the signal generation unit 506 may ascertain whether to generate a variation indication signal to cause rendering of differences between the functional characteristic and the functional attribute. In one example, such differences may be rendered on the graphical user interface 600 (though not illustrated). Rendering of the differences may help in assessing, for example, some performance bottlenecks in the current operations 106 (based on features indicated by the functional characteristics) or some shortcomings like inefficient implementations. Thus, the graphical user interface 600 may provide the user with recommendations of comprehensive details that may comply with the existing operations 106. The user, in one example, may appropriately choose to follow or perform the interlinked operations 106 based on the comprehensive details being recommended for the interlinked operations 106. Therefore, the system 102 may asses the operational workflow 104 and generate recommendations for possible enhancements or improvements thereof, and other advantages as discussed above.

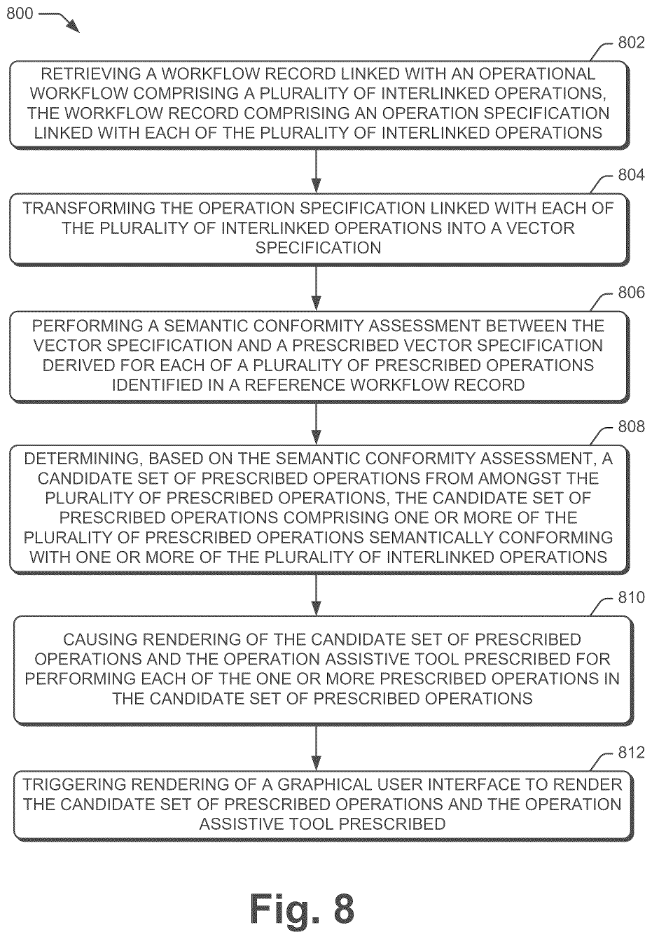

FIG. 8 illustrates an exemplary method 800 for assessment of an operational workflow and generating recommendations based on the assessment, according to one example implementation of the present subject matter. The order in which the method is described is not intended to be construed as a limitation, and any number of the described method blocks may be combined in any order to implement the method 800, or an alternative method. Furthermore, the method 800 may be implemented by processing resource or computing device(s) through any suitable hardware, non-transitory machine-readable instructions, or combination thereof.

It may also be understood that the method 800 may be performed by programmed computing devices, such as the processor 110, as depicted in FIGS. 4 and 5. Furthermore, the method 800 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 800 is described below with reference to the processor 110 and the system 102 as described above; other suitable systems for the execution of these methods may also be utilized. Additionally, the implementation of these methods is not limited to such examples. Further, FIG. 8 will be discussed in conjunction with FIGS. 1A to 7 for the sake of brevity and the description of FIGS. 1A to 7 shall be incorporated herein for reference.

At block 802, a workflow record, linked with an operational workflow comprising a plurality of interlinked operations, may be retrieved. In one example, the operational workflow may be linked with recall of one or more offerings. Examples of the offerings may include, but are not limited to, products, services, and platforms. In one example, the workflow record, such as the workflow record 202, may be retrieved from a data store, such as the data store 108. In another example, the workflow record may be retrieved from a user device, such as the workstation 112. Further, the workflow record may comprise an operation specification, such as the operation specification 204, linked with each of the plurality of interlinked operations, such as the plurality of operations 106. In one example, the operation specification may indicate a functional characteristic of each of the plurality of interlinked operations 106, as discussed above.

At block 804, the operation specification linked with each of the plurality of interlinked operations may be transformed into a vector specification. For example, the operation specification of each of the plurality of interlinked operations may be encoded into a corresponding vector specification. The vector specification, in one example, may include a plurality of vectors numerically representing the content of the operation specification from which they are encoded. As discussed in above example, different techniques may be used for transforming the operation specification into vector specification. Such techniques may include, but are not limited to, frequency-based representations, contextual representations encoding, statistical relationships between words, predefined embeddings, developed using large datasets, and utilization of one or more deep learning models.

At block 806, a semantic conformity assessment may be performed between the vector specification and a prescribed vector specification derived for each of a plurality of prescribed operations identified in a reference workflow record. As discussed above, the reference workflow record, such as the reference workflow record 302, may identify or indicate the plurality of prescribed operations, such as the plurality of prescribed operations 304 proposed or recommended for the operational workflow. That is, the reference workflow record may define or illustrate a wide range of proposed tasks, processes, or procedures that may probably optimise the functioning of the operational workflow, as discussed above.

Further, the reference workflow record may indicate various details about each prescribed operation. In one example, the reference workflow record 302 may indicate the plurality of prescribed operation specifications, such as the prescribed operation specification 306, where each prescribed operation may have a prescribed operation specification linked therewith, as illustrated in FIG. 3B. The prescribed operation specification may indicate, in one example, a functional attribute of each of the plurality of prescribed operations, as discussed above. Further, the prescribed vector specification for each of the plurality of prescribed operations identified in the reference workflow record may be derived, as discussed above.

In one example, the reference workflow record may also indicate an operation assistive tool, such as the operation assistive tool 310, prescribed for each of the plurality of prescribed operations. In one example, the prescribed operation assistive tool may be proposed or recommended means for performing an operation, such as the prescribed operation with which the operation assistive tool is linked. In one example, the prescribed operation assistive tools may be machinery, equipment, or mechanical tools usable in industrial environments. In another example, the prescribed operation assistive tools may be software applications or platforms, as discussed above. The reference workflow record 302 thus represents a vast and comprehensive set of data encompassing prescribed operation specifications and prescribed operation assistive tools for such prescribed operations, as also discussed above.

Further, the semantic conformity assessment may be performed between the vector specification, of the operation specification linked with each of the plurality of interlinked operations, and the prescribed vector specification of the prescribed operation specification linked with each of the plurality of prescribed operations. In one example, to perform the semantic conformity assessment, a similarity score may be computed for quantifying a semantic conformity or similarity between the vector specification, encoded based on the operation specification linked with each of the plurality of interlinked operations, and the prescribed vector specification derived for each of the plurality of prescribed operations. For example, the processor 110 may compare each vector specification with each prescribed vector specification. Based on the comparison of the vector specifications, the similarity score for each such comparison may be computed. The similarity score may be computed using any method, as discussed above.

The similarity score may then be compared with a threshold similarity score to identify one or more prescribed vector specifications, from amongst the prescribed vector specifications derived for each of the plurality of prescribed operations, semantically conforming with one or more vector specifications from amongst the vector specification encoded for each of the plurality of interlinked operations. If the similarity score, determined for each combination of a vector specification with a prescribed vector specification, is determined to be equal to or greater than the threshold similarity score, such combination of vector specification and prescribed vector specification may be determined to be semantically conforming or similar. The prescribed operation, linked with such semantically conforming prescribed vector specification, may accordingly be identified from amongst the plurality of prescribed operations. However, if the processor 110 determines that the similarity score, determined for each combination of a vector specification with a prescribed vector specification, is less than the threshold similarity score, the processor 110 may identify such combination of vector specification and prescribed vector specification to be semantically non-conforming.

At block 808, a candidate set of prescribed operations may be determined, based on the semantic conformity assessment, from amongst the plurality of prescribed operations. As discussed above, the prescribed operation, linked with semantically conforming prescribed vector specification, may be identified from amongst the plurality of prescribed operations. One or more of such prescribed operations may collectively be referred to as the candidate set of prescribed operations. That is, the candidate set of prescribed operations may comprise one or more of the plurality of prescribed operations that semantically conforms, based on the prescribed vector specification, with one or more of the plurality of interlinked operations of the operational workflow.

At block 810, rendering of the candidate set of prescribed operations and the operation assistive tool prescribed for performing each of the one or more prescribed operations in the candidate set of prescribed operations may be caused.

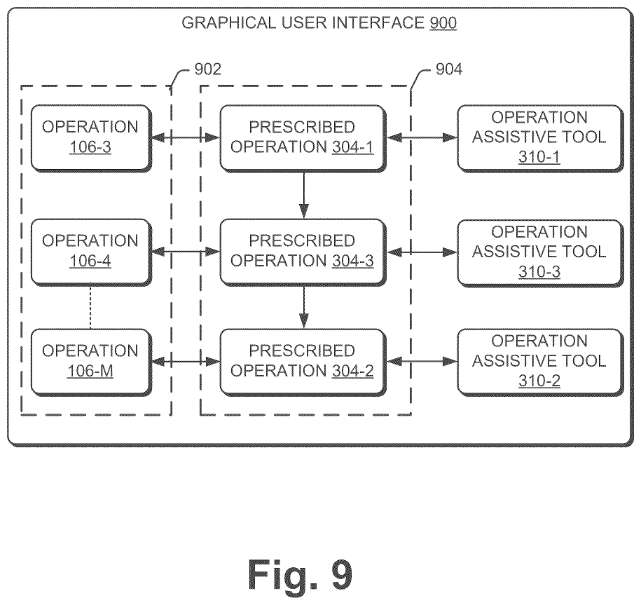

At block 812, rendering of a graphical user interface may be triggered to render the candidate set of prescribed operations and the operation assistive tool prescribed for performing each of the one or more prescribed operations in the candidate set of prescribed operations. In one example, to cause rendering of the candidate set of prescribed operations may, rendering of the graphical user interface may be triggered to indicate operation-tool combinations, as illustrated in FIG. 9. FIG. 9 illustrates a block diagram of a graphical user interface 900 indicating operation-tool combinations, according to one example implementation of the present subject matter. In one example, box 902 may indicate the interlinked operations, from amongst the plurality of interlinked operations of the operational workflow, whose operation specification was identified to be semantically conforming with the prescribed operation specifications of the prescribed operations. For example, based on the semantic conformity assessment, it may be determined that the operation specification linked with the operation 106-3 is semantically conforming with the prescribed operation specification linked with the prescribed operation 304-1. Similarly, multiple such prescribed operations, as indicated by box 904, may be identified and referred to as the candidate set of prescribed operations.

The graphical user interface 900 may also render the operation assistive tools linked with the prescribed operations added in the candidate set of prescribed operations. Such tools may be indicated to be linked with their corresponding prescribed operation. for example, the graphical user interface may indicate that the operation assistive tool 310-1 is linked with the prescribed operation 304-1. Similarly, for all the prescribed operations of the candidate set, corresponding operation assistive tools may be indicated. Such linkage may indicate the tools that may be suitable and/or recommended for performing the prescribed operation and, thereby the operations 106 linked therewith.

Further, in one example, the one or more prescribed operations in the candidate set of prescribed operations may indicate a prescribed sequence of execution of the one or more prescribed operations. In one example, the plurality of prescribed operations may be interlinked with each other. For example, the plurality of prescribed operations may be sequential operations where one prescribed operation depends on the completion of another. Based on such interlinkages, the one or more prescribed operations in the candidate set of prescribed operations may indicate the prescribed sequence of execution of the one or more prescribed operations. such an exemplary sequence may to perform the prescribed operation 304-1, followed by 304-3, and then by 304-2, as indicated by the graphical user interface 900.

Further, in one example, for the one or more of the plurality of prescribed operations semantically conforming with one or more of the plurality of interlinked operations, it may be determined whether the functional characteristics indicated by the operation specification linked with the one or more of the plurality of interlinked operations conforms with the functional attribute prescribed for the one or more of the plurality of prescribed operations. For example, the functional characteristics indicated by the operation specification 204-3 may be compared with the functional attribute indicated by the prescribed operation specification 306-1. Similarly, the functional characteristics of the interlinked operations 106, semantically conforming with one or more of the plurality of prescribed operations 304, may be compared with the functional attributes linked with those one or more of the plurality of prescribed operations 304. Based on the comparison, it may determine whether there is any difference between the functional characteristics and the functional attributes being compared. In case there is no difference, it may be ascertained that the functional characteristics are already comprehensive, up-to-date, and comply with the functional attributes. However, if it is determined that there exist differences between the functional characteristics and the functional attributes being compared, it may be determined that the functional characteristics may not be comprehensive and/or updated and there exist additional features in the functional attributes.

Based on the determination, it may be ascertained whether to cause rendering of differences between the functional characteristic and the functional attribute. In one example, if no differences are identified, rendering of the differences may not be cased. However, in case differences are determined, such differences may be rendered on the graphical user interface 600 or 900 (though not illustrated). Rendering of the differences may help in assessing, for example, some performance bottlenecks in the current operations 106 or some shortcomings, like inefficient implementations. Thus, the graphical user interface may provide the user with augmented recommendations of comprehensive details that may comply with the existing operations 106. The user, in one example, may appropriately choose to follow or perform the interlinked operations 106 based on the comprehensive details (prescribed operations specifications and/or operations assistive tools) being recommended for the interlinked operations 106. Therefore, the operational workflow 104 may be assessed and recommendations for possible enhancements or improvements thereof may accordingly be generated, along with other advantages as discussed above.

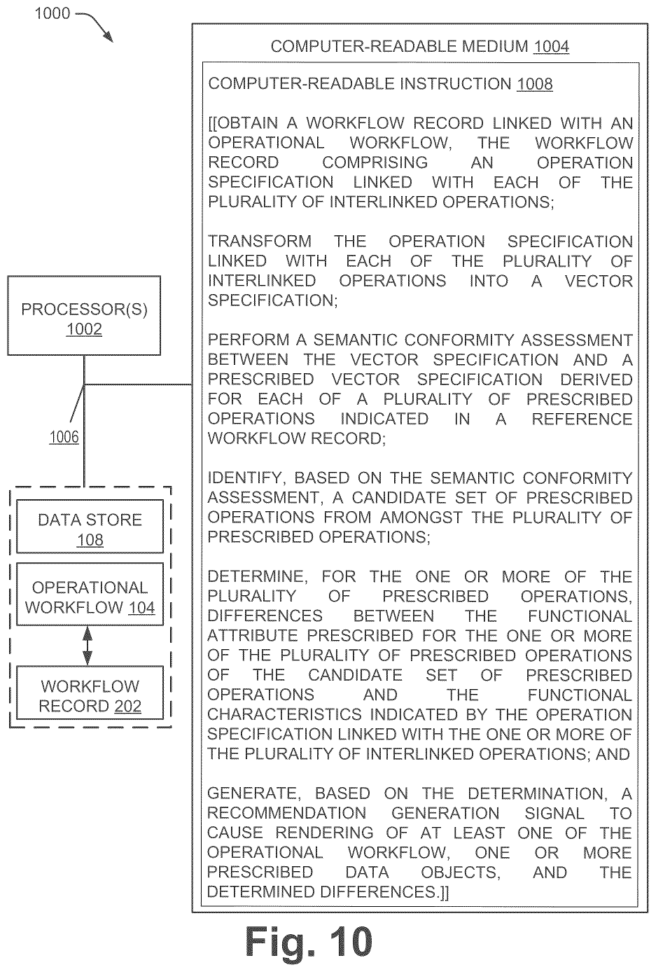

FIG. 10 illustrates a non-transitory computer-readable medium for assessing an operational workflow and generating a recommendation, according to one example implementation of the present subject matter. FIG. 10 will be discussed in conjunction with FIGS. 1A to 7 and 9, and the description of FIGS. 1A to 7 and 9 shall be incorporated herein for reference for the sake of brevity.

In an example, the computing environment 1000 includes a processor 1002 communicatively coupled to a non-transitory computer-readable medium 1004 through communication link 1006. In an example, the processor 1002 may have one or more processing resources for fetching and executing computer-readable instructions from the non-transitory computer-readable medium 1004. The processor 1002 and the non-transitory computer-readable medium 1004 may be implemented, for example, in the system 102.

The non-transitory computer-readable medium 1004 may be, for example, an internal memory device or an external memory. In an example implementation, the communication link 1006 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 1004 includes a set of computer-readable instructions 1008 which may be accessed by the processor 1002 through the communication link 1006 and subsequently executed for reconfiguring the data pipeline. The processor 1002 and the non-transitory computer-readable medium 1004 may also be communicatively coupled to the data store 108 and at least one of the operational workflow 104 and the workflow record 202.

Referring to FIG. 10, in an example, the non-transitory computer-readable medium 1004 includes computer-readable instructions 1008 that may cause the processor 1002 to obtain the workflow record 202 linked with the operational workflow 104. In one example, the workflow record 202 may be obtained in response to receiving a workflow assessment signal for evaluating the operational workflow 104 comprising the plurality of interlinked operations 106, as discussed above. The workflow record 202 may comprise, in one example, the operation specification 204 linked with each of the plurality of interlinked operations 106. The operation specification 204 may indicate a functional characteristic of each of the plurality of interlinked operations 106, as discussed above.

In an example, the non-transitory computer-readable medium 1004 includes computer-readable instructions 1008 that may cause the processor 1002 to encode the operation specification 204 linked with each of the plurality of interlinked operations 106 into a vector specification, as discussed above.

Further, in an example, the non-transitory computer-readable medium 1004 includes computer-readable instructions 1008 that may cause the processor 1002 to perform a semantic conformity assessment between the vector specification and a prescribed vector specification derived for each of the plurality of prescribed operations 304 identified in the reference workflow record 302. The reference workflow record 302 may indicate, in one example, the prescribed operation specification 306 linked with each of the plurality of prescribed operations 304. The prescribed operation specification 306 may indicate a functional attribute of each of the plurality of prescribed operations 304. The prescribed vector specification may be derived for each of the plurality of prescribed operations 304 based on the prescribed operation specification 306 linked with each of the plurality of prescribed operations 304. The reference workflow record 302 may also indicate the plurality of prescribed data objects 308, where one or more of the plurality of prescribed data objects 308 may be linked with at least one prescribed operation from amongst the plurality of prescribed operations 304. Also, in one example, the reference workflow record 302 may indicate the operation assistive tool 310 prescribed for performing each of the plurality of prescribed operations 304.

Further, to perform the semantic conformity assessment, the non-transitory computer-readable medium 1004 includes computer-readable instructions 1008 that may cause the processor 1002 to compute a similarity score for quantifying a semantic conformity or similarity between the vector specification, encoded based on the operation specification linked with each of the plurality of interlinked operations, and the prescribed vector specification derived for each of the plurality of prescribed operations, as discussed above. The similarity score may then be compared with a threshold similarity score to identify one or more prescribed vector specifications, from amongst the prescribed vector specifications derived for each of the plurality of prescribed operations, semantically conforming with one or more vector specifications from amongst the vector specification encoded for each of the plurality of interlinked operations. Based on the semantic conformity assessment, the processor 1002 may identify or determine a candidate set of prescribed operations. The candidate set of prescribed operations comprises one or more of the plurality of prescribed operations 304 semantically conforming with one or more of the plurality of interlinked operations 106 of the operational workflow 104.

Further, in an example, the non-transitory computer-readable medium 1004 includes computer-readable instructions 1008 that may cause the processor 1002 to determine, for the one or more of the plurality of prescribed operations of the candidate set of prescribed operations, differences between the functional attribute prescribed for the one or more of the plurality of prescribed operations and the functional characteristics indicated by the operation specification linked with the one or more of the plurality of interlinked operations. For example, the functional characteristics of the interlinked operations 106, semantically conforming with one or more of the plurality of prescribed operations 304, may be compared with the functional attributes linked with those one or more of the plurality of prescribed operations 304, as discussed above. Based on the comparison, the processor 1002 may determine the differences between the functional attribute and the functional characteristic.

Further, in an example, the non-transitory computer-readable medium 1004 includes computer-readable instructions 1008 that may cause the processor 1002 to generate, based on the determination, a recommendation generation signal to cause rendering of at least one of the operational workflow 104, one or more prescribed data objects 308 linked with each of the one or more prescribed operations 304 in the candidate set of prescribed operations, and the determined differences between the functional characteristics and the functional attribute. In one example, the generation of the recommendation generation signal may cause rendering of a graphical user interface, such as the graphical user interface 600. Though the graphical user interface 600 illustrates the operations 106-3 and 106-M, in another example, the complete workflow 104 can also be rendered on such a graphical user interface.

Further, in an example, the non-transitory computer-readable medium 1004 includes computer-readable instructions 1008 that may cause the processor 1002 to generate a tool recommendation signal to cause rendering of a recommendation indicating the operation assistive tool 310 prescribed for performing each of the one or more prescribed operations 304 in the candidate set of prescribed operations, as discussed above with reference to FIGS. 7 and 9. Therefore, the operational workflow 104 may be assessed and recommendations for possible enhancements for the operations 106 of the workflow 104, along with appropriate tools 310, may accordingly be indicated.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
obtain, in response to receiving a workflow assessment signal for evaluating an operational workflow comprising a plurality of interlinked operations, a workflow record linked with the operational workflow, the workflow record comprising an operation specification linked with each of the plurality of interlinked operations, the operation specification indicating a functional characteristic of each of the plurality of interlinked operations;
encode the operation specification linked with each of the plurality of interlinked operations into a vector specification;
perform a semantic conformity assessment between the vector specification and a prescribed vector specification derived for each of a plurality of prescribed operations identified in a reference workflow record, wherein the reference workflow record indicates:
a prescribed operation specification linked with each of the plurality of prescribed operations, the prescribed operation specification indicating a functional attribute of each of the plurality of prescribed operations, wherein the prescribed vector specification is derived, for each of the plurality of prescribed operations, based on the prescribed operation specification linked with each of the plurality of prescribed operations; and
a plurality of prescribed data objects, wherein one or more of the plurality of prescribed data objects are linked with at least one prescribed operation from amongst the plurality of prescribed operations;
identify, based on the semantic conformity assessment, a candidate set of prescribed operations, the candidate set of prescribed operations comprising one or more of the plurality of prescribed operations semantically conforming with one or more of the plurality of interlinked operations of the operational workflow; and
generate a recommendation generation signal to cause rendering of the candidate set of prescribed operations and one or more prescribed data objects linked with each of the one or more prescribed operations in the candidate set of prescribed operations.

2. The system of claim 1, wherein each of the plurality of prescribed data objects indicates at least one of:
data prescribed for a prescribed operation from amongst the plurality of prescribed operations; and
a characteristic of data prescribed for a prescribed operation from amongst the plurality of prescribed operations.

3. The system of claim 1, wherein, to perform the semantic conformity assessment, the processor is to:
compute a similarity score for quantifying a semantic conformity between the vector specification, encoded based on the operation specification linked with each of the plurality of interlinked operations, and the prescribed vector specification derived for each of the plurality of prescribed operations;
compare the similarity score with a threshold similarity score to identify one or more prescribed vector specifications, from amongst the prescribed vector specification derived for each of the plurality of prescribed operations, semantically conforming with one or more vector specifications from amongst the vector specification encoded for each of the plurality of interlinked operations, the one or more prescribed vector specifications being linked with the one or more of the plurality of prescribed operations; and
identify, based on the comparison, the candidate set of prescribed operations comprising the one or more of the plurality of prescribed operations, wherein the one or more of the plurality of prescribed operations semantically conform with one or more of the plurality of interlinked operations of the operational workflow.

4. The system of claim 1, wherein the processor is to cause rendering of a graphical user interface to indicate at least one of:
one or more of the plurality of interlinked operations semantically conforming with the candidate set of prescribed operations;
the operation specification linked with the one or more of the plurality of interlinked operations;
the candidate set of prescribed operations;
the prescribed operation specification linked with each prescribed operation in the candidate set of prescribed operations; and
one or more prescribed data objects linked with each of the one or more prescribed operations in the candidate set of prescribed operations.

5. The system of claim 4, wherein the processor is to cause rendering of one or more actionable components on the graphical user interface for each prescribed operation in the candidate set of prescribed operations, the one or more actionable components comprising:
a first actionable component to receive a positive feedback for the prescribed operation, the positive feedback indicating acceptance of the prescribed operation for the operational workflow;
a second actionable component to receive a negative feedback for the prescribed operation, the negative feedback indicating rejection of the prescribed operation for the operational workflow; and
a third actionable component to receive a modification feedback, the modification feedback indicating a request for modifying at least one of the prescribed operation specification and the prescribed data object linked with the prescribed operation.

6. The system of claim 5, wherein the reference workflow record further indicates at least one operation assistive tool prescribed for performing each of the plurality of prescribed operations.

7. The system of claim 6, wherein, in response to receiving the positive feedback for a prescribed operation from amongst the candidate set of prescribed operations, the processor is to generate a tool recommendation signal to cause rendering of a recommendation indicating the at least one operation assistive tool prescribed for performing the prescribed operation.

8. The system of claim 1, wherein, for the one or more of the plurality of prescribed operations semantically conforming with one or more of the plurality of interlinked operations, the processor is to:
determine whether the functional characteristics indicated by the operation specification linked with the one or more of the plurality of interlinked operations conforms with the functional attribute prescribed for the one or more of the plurality of prescribed operations; and
ascertain, based on the determination, whether to generate a variation indication signal to cause rendering of differences between the functional characteristic and the functional attribute.

9. The system of claim 1, wherein the functional characteristic, linked with each of the plurality of interlinked operations, indicates at least one of a purpose and a probable outcome of the each of the plurality of interlinked operations.

10. A method comprising:
retrieving a workflow record linked with an operational workflow comprising a plurality of interlinked operations, the workflow record comprising an operation specification linked with each of the plurality of interlinked operations, the operation specification indicating a functional characteristic of each of the plurality of interlinked operations;
transforming the operation specification linked with each of the plurality of interlinked operations into a vector specification;
performing a semantic conformity assessment between the vector specification and a prescribed vector specification derived for each of a plurality of prescribed operations identified in a reference workflow record, wherein the reference workflow record indicates at least one of:
a prescribed operation specification linked with each of the plurality of prescribed operations, the prescribed operation specification indicating a functional attribute of each of the plurality of prescribed operations, wherein the prescribed vector specification is derived, for each of the plurality of prescribed operations, based on the prescribed operation specification linked with each of the plurality of prescribed operations; and
an operation assistive tool prescribed for performing each of the plurality of prescribed operations;
determining, based on the semantic conformity assessment, a candidate set of prescribed operations from amongst the plurality of prescribed operations, the candidate set of prescribed operations comprising one or more of the plurality of prescribed operations semantically conforming with one or more of the plurality of interlinked operations of the operational workflow; and
causing rendering of the candidate set of prescribed operations and the operation assistive tool prescribed for performing each of the one or more prescribed operations in the candidate set of prescribed operations.

11. The method of claim 10, wherein the method further comprises trigger rendering of a graphical user interface to render the candidate set of prescribed operations and the operation assistive tool prescribed for performing each of the one or more prescribed operations in the candidate set of prescribed operations.

12. The method of claim 11, wherein the graphical user interface is to indicate operation-tool combinations, the operation-tool combinations indicating a linkage between each of the one or more prescribed operations, in the candidate set of prescribed operations, and the operation assistive tool prescribed for each of the one or more prescribed operations.

13. The method of claim 10, wherein the one or more prescribed operations in the candidate set of prescribed operations indicate a prescribed sequence of execution of the one or more prescribed operations.

14. The method of claim 10, wherein the method further comprises:
determining whether the functional characteristics indicated by the operation specification linked with the one or more of the plurality of interlinked operations conforms with the functional attribute prescribed for the one or more of the plurality of prescribed operations; and
ascertain, based on the determination, whether to cause rendering of differences between the functional characteristic and the functional attribute.

15. The method of claim 10, wherein the method further comprises:
computing a similarity score for quantifying a semantic conformity between the vector specification, encoded based on the operation specification linked with each of the plurality of interlinked operations, and the prescribed vector specification derived for each of the plurality of prescribed operations;
comparing the similarity score with a threshold similarity score to identify one or more prescribed vector specifications, from amongst the prescribed vector specification derived for each of the plurality of prescribed operations, semantically conforming with one or more vector specifications from amongst the vector specification encoded for each of the plurality of interlinked operations, the one or more prescribed vector specifications being linked with one or more of the plurality of prescribed operations; and
determining, based on the comparison, the candidate set of prescribed operations comprising the one or more of the plurality of prescribed operations, wherein the one or more of the plurality of prescribed operations semantically conform with one or more of the plurality of interlinked operations of the operational workflow.

16. The method of claim 10, wherein the operational workflow is linked with recall of one or more offerings.

17. A non-transitory computer-readable medium comprising instructions, the instructions being executable by a processing resource to:
obtain, in response to receiving a workflow assessment signal for evaluating an operational workflow comprising a plurality of interlinked operations, a workflow record linked with the operational workflow, the workflow record comprising an operation specification linked with each of the plurality of interlinked operations, the operation specification indicating a functional characteristic of each of the plurality of interlinked operations;
transform the operation specification linked with each of the plurality of interlinked operations into a vector specification;
perform a semantic conformity assessment between the vector specification and a prescribed vector specification derived for each of a plurality of prescribed operations indicated in a reference workflow record, wherein the reference workflow record indicates at least one of:
a prescribed operation specification linked with each of the plurality of prescribed operations, the prescribed operation specification indicating a functional attribute of each of the plurality of prescribed operations, wherein the prescribed vector specification is derived, for each of the plurality of prescribed operations, based on the prescribed operation specification linked with each of the plurality of prescribed operations; and
a plurality of prescribed data objects, wherein one or more of the plurality of prescribed data objects are linked with at least one prescribed operation from amongst the plurality of prescribed operations;
identify, based on the semantic conformity assessment, a candidate set of prescribed operations from amongst the plurality of prescribed operations, the candidate set of prescribed operations comprising one or more of the plurality of prescribed operations semantically conforming with one or more of the plurality of interlinked operations of the operational workflow;
determine, for the one or more of the plurality of prescribed operations, differences between the functional attribute prescribed for the one or more of the plurality of prescribed operations of the candidate set of prescribed operations and the functional characteristics indicated by the operation specification linked with the one or more of the plurality of interlinked operations; and
generate, based on the determination, a recommendation generation signal to cause rendering of at least one of the operational workflow, one or more prescribed data objects linked with each of the one or more prescribed operations in the candidate set of prescribed operations, and the determined differences between the functional characteristics and the functional attribute.

18. The non-transitory computer-readable medium of claim 17, the instructions being executable by the processing resource to:
compute a similarity score for quantifying a semantic conformity between the vector specification, encoded based on the operation specification linked with each of the plurality of interlinked operations, and the prescribed vector specification derived for each of the plurality of prescribed operations;
compare the similarity score with a threshold similarity score to identify one or more prescribed vector specifications, from amongst the vector specification derived for each of the plurality of prescribed operations, semantically conforming with one or more vector specifications from amongst the vector specification encoded for each of the plurality of interlinked operations, the one or more prescribed vector specifications being linked with one or more of the plurality of prescribed operations; and
determine, based on the comparison, the candidate set of prescribed operations comprising the one or more of the plurality of prescribed operations semantically conforming with one or more of the plurality of interlinked operations of the operational workflow.

19. The non-transitory computer-readable medium of claim 17, wherein the reference workflow record further indicates an operation assistive tool prescribed for performing each of the plurality of prescribed operations.

20. The non-transitory computer-readable medium of claim 19, the instructions being executable by the processing resource to generate a tool recommendation signal to cause rendering of a recommendation indicating the operation assistive tool prescribed for performing each of the one or more prescribed operations in the candidate set of prescribed operations.
